(19) United States
(12) Patent Application Publication
(10) Pub. No.: US 2018/0333851 A1
(43) Pub. Date: Nov. 22, 2018

(54) MODULAR ROBOTIC SYSTEM FOR LABORATORY DIAGNOSTICS

(71) Applicant: Counsyl, Inc., South San Francisco, CA (US)

(72) Inventors: Kyle Allen LAPHAM, San Francisco, CA (US); Nathan Phillip ELDRIDGE, San Francisco, CA (US)

(21) Appl. No.: 15/982,861

(22) Filed: May 17, 2018

Related U.S. Application Data
(60) Provisional application No. 62/508,693, filed on May 19, 2017.

(51) Int. Cl. B25J 9/16; B25J 9/00

(52) U.S. Cl. CPC B25J 9/1664; B25J 9/0009; Y10S 901/27; Y10S 901/41; Y10S 901/09

(57) ABSTRACT

Described herein is a modular robotic system for processing a biological sample, and methods of using a modular robotic system for processing a biological sample. The modular robotic system includes a bidirectional plate transportation track to transport plates within the modular robotic system, as well as robotic arms that can transport the plate from a node on the bidirectional plate transportation tack to a sample processing module. Through this system, the sample and/or consumable plates can be transported throughout the processing system. Additionally, the modular robotic system is configured to be expandable, so that the system can be easily adapted to scale up biological sample processing laboratories.

### CROSS-REFERENCE TO RELATED APPLICATION

This application claims priority benefit of U.S. Provisional Application No. 62/508,693, filed May 19, 2017, entitled “MODULAR ROBOTIC SYSTEM FOR LABORATORY DIAGNOSTICS,” the entire contents of which is incorporated herein by reference for all purposes.

### TECHNICAL FIELD

The present invention relates to a modular robotic system for processing biological samples, and methods of using the same.

### BACKGROUND

Automated sample processing systems can receive samples (such as biological test samples) and process the samples for various purposes, such as extracting DNA from a biological sample, preparing a nucleic acid sample for sequencing, or conducting one or more assays on the sample. For example, the QIAGEN QIAsymphony® system is an automated system that can receive biological samples and isolate DNA. While such automated systems are useful in an experimental laboratory setting or a low-throughput laboratory, such systems do not scale well for a large-scale clinical diagnostic laboratory. For example, a large-scale clinical genetic sequencing laboratory may process hundreds or thousands of samples per day, including extracting nucleic acids from a sample and preparing the extracted nucleic acids for sequencing.

### SUMMARY

Described herein a modular robotic system useful for processing a biological sample. In some embodiments, the modular robotic system comprises: two or more sample processing modules; a water supply system connected to the two or more sample processing modules, the water supply system comprising a main water supply conduit and one or more water supply manifolds; a liquid waste disposal system connected to the two or more sample processing modules, the liquid waste disposal system comprising a main liquid waste disposal conduit and one or more liquid waste disposal manifolds connected to at least one sample processing module; one or more power supply systems connected to a main power supply line and at least one of the sample processing modules; a bidirectional plate transportation track configured to transport a plate between at least a first node and a second node; and a first robotic arm configured to transport the plate between the first node and a first sample processing module, and a second robotic arm configured to transport the plate between the second node and a second sample processing module.

In some embodiments, the second sample processing module and the second node are unreachable by the first robotic arm, and the first sample processing module and the first node are unreachable by the second robotic arm. In some embodiments, the modular robotic system comprises a third robotic arm disposed between the first robotic arm and the second robotic arm, wherein the bidirectional plate transportation track is configured to transport the plate from the first node and the second node without the plate contacting the third robotic arm. In some embodiments, the modular robotic system comprises a third robotic arm disposed between the first robotic arm and the second robotic arm, wherein the bidirectional plate transportation track is configured to transport the plate between the first node and the second node without the plate contacting the third robotic arm.

In some embodiments, the water supply system comprises an extendable terminus. In some embodiments, the water supply system comprises a valve disposed between a water supply manifold and a sample processing module. In some embodiments, the water supply system comprises a pressure regulator disposed between a water supply manifold and a sample processing module. In some embodiments, the water supply system comprises a flow sensor disposed along the main water supply conduit. In some embodiments, the water supply system comprises a pressure regulator disposed along the main water supply conduit. In some embodiments, the water supply system terminus is disposed at an end of the main water supply conduit. In some embodiments, the water supply system terminus is a valve. In some embodiments, the main water supply conduit is configured to be extendable from the water supply system terminus.

In some embodiments, the power supply system comprises a transformer configured to receive power from the main power supply line and supply single phase 240 VAC power to one or more sample processing modules. In some embodiments, the power supply system is configured to receive power from the main power supply line and supply three-phase 208 VAC, single-phase 120 VAC, or 24 VDC power to one or more sample processing modules. In some embodiments, the power supply system comprises a battery.

In some embodiments, the modular robotic system further comprises a data network configured to provide communication between the two or more sample processing modules and a computer system. In some embodiments, the data network comprises one or more switches, wherein the one or more switches are connected to the two or more sample processing modules and the computer system.

In some embodiments, the liquid waste disposal system comprises an expandable liquid waste disposal system terminus. In some embodiments, the liquid waste disposal system comprises a valve or regulator disposed between one of the one or more liquid waste disposal manifolds and one of the two or more sample processing modules. In some embodiments, the valve or regulator disposed between the liquid waste disposal manifold and the sample processing module is operable to selectively open only when flow of liquid waste from any other sample processing module to the liquid waste disposal system is prevented. In some embodiments, the valve or regulator is operable to selectively open according to a liquid waste disposal prioritization schedule. In some embodiments, the liquid waste disposal system comprises a pump disposed between the liquid waste disposal manifold and one of the two or more sample processing modules. In some embodiments, the pump disposed between the liquid waste disposal manifold and the sample processing module is operable to selectively pump liquid waste into the liquid waste disposal system only when flow of liquid waste from any other sample processing module to the liquid waste disposal system is prevented. In some embodiments, the pump is operable to selectively pump liquid waste into the liquid waste disposal system according to a liquid waste prioritization schedule. In some embodiments, the liquid waste disposal system comprises a flow sensor or a pressure regulator disposed along the main liquid waste disposal conduit. In some embodiments, the liquid waste disposal system comprises a pump disposed along the main liquid waste disposal conduit. In some embodiments, the liquid waste disposal system terminus is disposed at an end of the main liquid waste disposal conduit. In some embodiments, the liquid waste disposal system terminus is a valve. In some embodiments, the main liquid waste disposal conduit is configured to be extendable from the water supply system terminus.

In some embodiments, the modular robotic system further comprises a vacuum system connected to the two or more sample processing modules, the vacuum system comprising a main vacuum conduit and one or more vacuum manifolds. In some embodiments, the vacuum system further comprises an extendable terminus. In some embodiments, the vacuum system further comprises a valve disposed between one of the one or more vacuum manifolds and one of the two or more sample processing modules. In some embodiments, the valve disposed between the vacuum manifold and the sample processing module is operable to selectively open only when vacuum to any other sample processing module from the vacuum system is prevented. In some embodiments, the valve is operable to selectively open according to a vacuum system prioritization schedule. In some embodiments, the vacuum system terminus is disposed at an end of the main vacuum conduit. In some embodiments, the vacuum system terminus is a valve.

In some embodiments, the modular robotic system comprises a compressed gas system connected to the two or more sample processing modules, the compressed gas system comprising a main compressed gas supply conduit and one or more compressed gas manifolds. In some embodiments, the compressed gas system further comprises an extendable compressed gas system terminus. In some embodiments, the compressed gas system further comprises a valve disposed between one of the one or more compressed gas manifolds and one of the two or more sample processing modules. In some embodiments, the valve disposed between the compressed gas manifold and the sample processing module is operable to selectively open only when compressed gas to any other sample processing module from the compressed gas system is prevented. In some embodiments, the valve is operable to selectively open according to a compressed gas system prioritization schedule. In some embodiments, the compressed gas system terminus is disposed at an end of the main compressed gas supply conduit. In some embodiments, the compressed gas system terminus is a valve.

In some embodiments, the modular robotic system further comprises a light curtain disposed along the perimeter of the modular robot, wherein penetration of the light curtain suspends operation of at least one of the robotic arms. In some embodiments, penetration of the light curtain suspends operation of one robotic arm without suspending operation of the other robotic arms in the modular robotic system.

In some embodiments, the modular robotic system comprises a plate input/output module comprising: a plate identifier configured to identify a plate or a type of plate; a plate nest, wherein at least one of the robotic arms is configured to retrieve a plate from the plate nest or transport a plate to the plate nest; and an input signaler configured to submit a request to a computer system, which operates the robotic arm to retrieve the plate from the plate nest. In some embodiments, the plate nest is positioned between a first light curtain and a second light curtain, and the first light curtain is positioned between the plate nest and the robotic arm, wherein simultaneous penetration of the first light curtain and the second light curtain suspends operation of the robotic arm. In some embodiments, in response to the computer system receiving a user request for an identified sample or an identified plate, the robotic arm is operable to retrieve the identified sample or the identified plate and position the identified sample or the identified plate within the plate nest of the input/output module.

In some embodiments, the modular robot comprises a plate loading module. In some embodiments, the plate loading module is configured to determine how many plates of a particular plate type are in the plate loading module. In some embodiments, the plate loading module determines how many plates of a particular plate type are in the plate loading module based on the height of a plate stack or a weight of a plate stack.

In some embodiments, the modular robotic system comprises a barcode applicator.

In some embodiments of the modular robotic system described above, the plate is a sample plate or a consumable plate.

Biological samples can be processed using the modular robotic system. In some embodiments, there is provided a method of processing a biological sample in a modular robotic system, comprising: routing a plate to a first node using a first robotic arm; routing the plate from the first node to a second node, the second node inaccessible by the first robotic arm; routing the plate from the second node to a sample processing module using a second robotic arm; routing the plate from the sample processing module to the second node using the second robotic arm; and routing the plate from the second node to the first node.

In some embodiments, there is provided a method of processing a biological sample in a modular robotic system, comprising: routing a plate to a first node using a first robotic arm; routing the plate from the first node to a second node, the second node being inaccessible by the first robotic arm; and routing the plate from the second node to a sample processing module using a second robotic arm; wherein a third robotic arm is disposed between the first robotic arm and the second robotic arm, and the third robotic arm is bypassed when the plate is transported from the first node to the second node. In some embodiments, the method further comprises routing the plate from the sample processing module to the second node using the second robotic arm; and routing the plate from the second node to the first node.

In some embodiments of the methods described above, the plate is a sample plate. In some embodiments, the method further comprises processing a sample in the sample plate at the sample processing module. In some embodiments, the method further comprises routing the plate from the first node to a second processing module using the first robotic arm. In some embodiments, the method further comprises processing a sample in the sample plate at the second sample processing module.

In some embodiments of the methods described above, the plate is a consumable plate.

In some embodiments, there is provided a method of processing a biological sample in a modular robotic system, comprising: dynamically routing a sample plate to a selected sample processing module based on stateful data and a defined workflow process, the sample processing module selected from a plurality of sample processing modules based on a real-time load of each of the sample processing modules, wherein a first portion of the plurality of sample processing modules is accessible by a first robotic arm and inaccessible by a second robotic arm, and wherein a second portion of the plurality of sample processing modules is accessible by the second robotic arm and inaccessible by the first robotic arm. In some embodiments, the sample processing modules are redundant. In some embodiments, the second portion of the plurality of sample processing modules comprises the selected sample processing module, and dynamically routing the plate comprises transporting the sample from a first node accessible by the first robotic arm and inaccessible by the second robotic arm to a second node accessible by the second robotic arm and inaccessible by the first robotic arm. In some embodiments, the method further comprises processing a sample in the sample plate at the selected sample processing module.

In some embodiments of the methods described above, the method further comprises receiving a plate input request.

In some embodiments of the methods described above, the method further comprises receiving the plate from an input/output module using the first robotic arm.

In some embodiments of the methods described above, the method further comprises receiving a plate output request.

In some embodiments of the methods described above, the method further comprises routing the plate to an input/output module using the first robotic arm.

In some embodiments of the methods described above, the method further comprises monitoring a liquid waste volume in a plurality of liquid waste containers; and disposing of liquid waste contained with the plurality of liquid waste containers according to a liquid waste prioritization schedule.

In some embodiments of the methods described above, the plate is routed using a bidirectional plate transportation track.

### BRIEF DESCRIPTION OF THE DRAWINGS

FIG. 1A illustrates an exemplary modular robotic system with three cells, each of which include a robotic arm.

FIG. 1B illustrates an exemplary expansion of the modular robotic system illustrated in FIG. 1A.

FIG. 1C illustrates another exemplary expansion of the modular robotic system illustrated in FIG. 1A.

FIG. 1D illustrates an exemplary robotic arm that can be used with the modular robotic system.

FIG. 2 illustrates an exemplary vacuum system of an exemplary modular robotic system, along with an optional vacuum module integration unit.

FIG. 3 illustrates an exemplary compressed gas system of an exemplary modular robotic system.

FIG. 4 illustrates an exemplary liquid waste disposal system of an exemplary modular robotic system, with an optional liquid waste disposal module integration unit.

FIG. 5 illustrates an exemplary water supply system of a modular robotic system.

FIG. 6A illustrates an exemplary power supply system for a modular robotic system.

FIG. 6B illustrates an exemplary main control panel of a power supply system.

FIG. 6C illustrates an exemplary power supply module integration unit of a power supply system.

FIG. 7 illustrates an exemplary method of processing a biological sample using a modular robotic system.

FIG. 8 illustrates an exemplary computing system or electronic device for implementing the examples of the disclosure.

### DETAILED DESCRIPTION

The modular robotic system described herein can be quickly scaled-up to allow for high-throughput sample processing. The system includes a plurality of sample processing modules, and samples can be routed from one sample processing module to another sample processing module using a network of robotic arms and a bidirectional plate transportation track. The system can be divided into a plurality of cells, with a robotic arm routing plates within the cell. The multiple cells are interconnected by a bidirectional plate transportation track, which can transport a plate from a node within one cell to a node within another cell, which need not be adjacent. One or more sample processing modules are arranged along the perimeter of a cell, and the robotic arm can route a plate to or from a sample processing module within the cell. For example, the robotic arm can route a plate from a first sample processing module to a second sample processing module within the cell. The robotic arm can also route a plate to or from a node on the bidirectional plate transportation track within the cell to or from a sample processing module.

The modular robotic system can also include one or more support systems, such as a water supply system, a liquid waste disposal system, a vacuum system, or a compressed gas system. One or more of these support systems can interconnect the cells within the modular robotic system to provide laboratory infrastructure if needed to operate any one or more sample processing modules.

The modular robotic system described herein can be easily expanded to increase sample processing capacity by adding cells without needing to add substantial infrastructure or suspend operation of the modular robotic system. For example, the water supply system, the liquid waste disposal system, the vacuum system, and/or the compressed gas system can include a terminus through which the support system can be expanded to support an adjacent cell. In some embodiments, the bidirectional plate transportation track is expandable through a terminus, or an additional bidirectional plate transportation track can be installed (for example, above, below, or adjacent to the existing bidirectional plate transportation track). The relatively easy expansion of the modular robotic system allows for rapid scale-up of the system, which relieves an otherwise substantial burden on a quickly growing clinical laboratory.

The configuration of the modular robotic system can also allow for rapid routing of plates (for example, sample plates) from a first sample processing module in a first cell to a second sample processing module in a second cell, which may be non-adjacent (that is, spaced by one or more cells). A robotic arm can route a plate to a first node of a plate transportation track (which may be bidirectional). Once the plate is at the first node of the plate transportation track, it can be transported to any other node on the plate transportation track in a single step. That is, to transport the plate from a first node to a second node, there is no need for the plate to stop at an intermediate node or robotic arm. For example, in some embodiments, a first robotic arm routes a plate to a first node; the plate is transported from the first node to a second node, the second node being inaccessible by the first robotic arm; and a second robotic arm routes the plate to a sample processing module, wherein a third robotic arm is disposed between the first robotic arm and the second robotic arm (the third robotic arm being accessible to a node between the first node and the second node), and the third robotic arm is bypassed when the plate is transported from the first node to the second node. Using this method, efficiency is maximized because no plate is more than three movement steps from any sample processing module in the modular robotic system. In a first step, a plate is routed from a first sample processing module to node i by robotic arm i within cell i. In a second step, the plate is transported along the plate transportation track directly from the node i to node n within cell n. In the third step, the plat is routed from node n to a second sample processing module by robotic arm n.

In some embodiments, there is a method of processing a biological sample in a modular robotic system, comprising: sending movement information to a first robotic arm to route a plate to a first node; transporting the plate from the first node to a second node inaccessible by the first robotic arm; and sending movement information to a second robotic arm to route the plate to a sample processing module; wherein a third robotic arm is disposed between the first robotic arm and the second robotic arm, and the third robotic arm is bypassed when the plate is transported from the first node to the second node.

In another advantage of the modular robotic system described herein, samples can be processed bidirectionally. In previous automated systems, samples are processed in a unidirectional manner; the sample is processed in a first sample processing module, then a downstream second sample processing module, then a downstream third sample processing module. In contrast, using the modular robotic system described herein, a sample can be processed in a first sample processing module in a first cell, be transported to a second cell and processed by a second sample processing module in the second cell, then be transported back to the first cell to be processed by a third sample processing module in the first cell. In some embodiments, there is provided a method of processing a biological sample in a modular robotic system, comprising: sending movement information to a first robotic arm to route a plate to a first node; transporting the plate from the first node to a second node, the second node inaccessible by the first robotic arm; sending movement information to a second robotic arm to route the plate to a sample processing module; sending movement information to the second robotic arm to route the plate from the sample processing module to the second node; and transporting the plate from the second node to the first node.

The modular robotic system utilizing the bidirectional plate transportation track provides several advantages over previous automated systems. First, the modular robotic system can efficiently process multiple sample plates with different defined workflow processes. For example, if a first sample plate is processed by sample processing module A, then sample processing module B, then sample processing module C, then sample processing module D, whereas a second sample plate is processed by sample processing module A, then sample processing module D, then sample processing module B, a unidirectional system would require an additional sample processing module B downstream of sample processing module D. In contrast, in the modular robotic system describe herein, sample processing modules A, B, and C can be located in a first cell and sample processing module D can be located in a second cell. The second sample plate can be processed at sample processing module A in the first cell, transported to the second cell to be processed by sample module D, then returned to the first cell using the bidirectional plate transportation track to be processed by sample processing modules B and C in the first cell.

The configuration of the modular robotic system also allows for load balancing when one or more of the sample processing modules operates at a lower throughput rate than other sample processing modules in a given defined workflow process. For example, if a defined workflow process requires a sample be processed by sample processing module A, then sample processing module B, then sample processing module C, but sample processing module B operates at half the throughput as sample processing modules A and C, then twice the number of sample processing module B would be required to utilize the full capacity of sample processing modules A and C. Full capacity may not be necessary at the initial stage of operation of the modular robotic system; however scale up would require the addition of a second sample processing module B. Adding a second sample processing module B to the same cell that contains sample processing module A, sample processing module C, and the first sample processing module B may not be practical due to special limitations or the need to suspend operation of automated system (for example, due to safety reasons during the addition of infrastructure). Using the configuration of the modular robotic system described herein, the second sample processing module B can be added to a different cell without needing to suspend operation of the other sample processing modules or cells.

In another advantage, the modular robotic system described herein can remain in operation if a given sample processing module breaks down or needs to be suspended for maintenance by including a redundant sample processing module elsewhere in the modular robotic system. For example, using the workflow process described above (A→B→C), the modular robotic system can be equipped with a redundant sample processing module B. If the first sample processing module B is suspended for any reason, the modular robotic system can continue to operate using the redundant sample processing module B.

The modular robotic system can dynamically route a sample plate to a sample processing module based on stateful data and a defined workflow process. The sample processing module to which the sample plate is routed can be selected based on a real-time load of the sample processing module. That is, if the sample processing module is in use (e.g., by processing a different sample plate) or suspended (e.g., due to malfunction or maintenance), the sample plate is routed to a holding nest or a redundant sample processing module. The holding nest or redundant sample processing module can be located in any cell within the modular robotic system, and the sample plate can be transported to the cell using the bidirectional plate transportation track. In some embodiments, there is a method of processing a biological sample in a modular robotic system, comprising sending movement information to a first robotic arm to receive a sample or consumable; and dynamically routing the sample or consumable to a first sample processing module based on stateful data and a defined workflow process, the first sample processing module selected from a plurality of redundant sample processing modules based on a real-time load of each of the redundant sample processing modules, wherein a first portion of the plurality of redundant sample processing modules is accessible by the first robotic arm and inaccessible by a second robotic arm, and wherein a second portion of the plurality of redundant sample processing modules is accessible by the second robotic arm and inaccessible by the first robotic arm. In some embodiments, the second portion of the plurality of redundant sample processing modules comprises the first sample processing module, and dynamically routing the sample comprises transporting the sample from a first node accessible by the first robotic arm and inaccessible by the second robotic arm to a second node accessible by the second robotic arm and inaccessible by the first robotic arm.

Another advantage of the modular robotic system described herein is the adaptability of modular robotic system to incorporate new defined workflow processes. Equipment in a clinical laboratory may be upgraded, new sample processing modules introduced, and new workflow processes developed. New sample processing modules can be added to the modular robotic system without suspending operation of the system by adding a new cell including the new sample processing module(s) or by adding the new sample processing module to the perimeter of an existing cell, if space allows.

As used herein, the singular forms “a,” “an,” and “the” include the plural reference unless the context clearly dictates otherwise.

Reference to “about” a value or parameter herein includes (and describes) variations that are directed to that value or parameter per se. For example, description referring to “about X” includes description of “X”.

The term “cell” refers to a section of the modular robotic system that includes a robotic arm and node on a bidirectional plate transportation track. The perimeter of the cell includes one or more modules (e.g., a sample processing module, input/output module, holding nest, etc.) that are directly accessible by the robotic arm of that cell, but not to a robotic arm of an adjacent cell.

A module or node that is “inaccessible” to a robotic arm means that the module or node is not directly accessible, and the robotic arm cannot directly move a plate to that module or node. A module or node that is accessible by a first robotic arm only through a plate transportation track or a second robotic arm is considered “inaccessible” to the first robotic arm.

An “input/output module” is any module or device that allows for (1) input, (2) output, or (3) both input and output of one or more plates in the modular robotic system. The plates can be transferred to or from (depending on the configuration) the input/output module by a robotic arm so that the plates can be routed throughout the modular robotic system. A user can also receive plates from or send plates to an input/output module so that they can be routed. Thus, direct interaction between a user and a robotic arm is not necessary for the modular robotic system to function.

A “manifold” is any device that provides a junction for a conduit, and can divide the conduit into two or more, three or more, four or more, five or more, six or more, seven or more, or eight or more conduits.

A “node” is a predetermined location on a plate transportation track that is associated with a particular cell of the modular robotic system.

It is understood that aspects and variations of the invention described herein include “consisting” and/or “consisting essentially of” aspects and variations.

Where a range of values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

It is to be understood that one, some or all of the properties of the various embodiments described herein may be combined to form other embodiments of the present invention. The section headings used herein are for organizational purposes only and are not to be construed as limiting the subject matter described.

### Modular Robotic Systems

The modular robotic system includes a plurality of sample processing modules (for example, modules for DNA extraction, sequencing library preparation, or sample preparation for one or more assays, modules for conducting assays), a bidirectional sample transportation track, and two or more robotic arms. The modular robotic system can further include a water supply system, a power supply system, a compressed gas system, a vacuum system, a data network, and/or a liquid waste disposal system. The water supply system is connected to the plurality of sample processing modules, and comprises a main water supply conduit, a plurality of water supply manifolds, and a main water supply conduit terminus. The liquid waste disposal system is also connected to the plurality of sample processing modules and comprises a main liquid waste disposal conduit, a pump, a plurality of liquid waste disposal manifolds, and a main liquid waste disposal conduit terminus. The bidirectional sample transportation track is configured to transport a sample (which may be contained within a plate) between two or more nodes, and the two or more robotic arms are configured to transport the sample between at least one of the nodes and at least one sample processing module. The power supply system is connected to a main power supply line (e.g., a building power supply) and to at least one of the sample processing modules. In some embodiments, the first robotic arm is configured to transport the sample between a first node and a first sample processing module, and a second robotic arm is configured to transport the sample between a second node and a second processing module. In some embodiments, the first robotic arm is not configured to not access the second node or the second sample processing module, and the second robotic arm is configured to not access the first node or the first sample processing module. In some embodiments, the robotic system comprises one or more safety features, such as one or more light curtains or a plate input/output module.

The modular robotic systems can receive one or more samples, such as biological samples, and process the samples using one or more sample processing modules. The sample processing modules can include automated equipment modules for extracting DNA from a sample, adding one or more reagents to a sample, or performing one or more assays on a sample. For example, the sample processing modules can include a liquid handling apparatus (such as a pipette system, a liquid dispenser, or a liquid aspirator), an incubator, a shaker or orbiter, or a device to perform an assay (such as a fluorimeter, a camera, or other imaging device). To operate, the sample processing modules generally rely on one or more sample processing support systems, such as a water supply system, a power supply system, a liquid waste disposal system, a data network, or a vacuum system, as further described herein. Further, the one or more sample processing systems may use one or more consumable components (such as reagents, pipette tips, or sample tubes), which can be routed through the modular robotic system as described herein.

The samples can be contained within a plate, such as a 24-sample plate, a 96-sample plate, or a 386-sample plate. The plate can hold the sample, for example, in an individual sample well or an individual sample tube. The plate or sample tube can include an identifier, such as a barcode, which can be used to associate the sample with stateful data, sample position (e.g., sample position within the plate, or sample position within the modular robotic system). The modular robotic system can receive the sample or plate through an input/output module, which can limit interaction between the robotic arms of the modular robotic system and a human user.

The modular robotic system can also receive one or more consumable components (for example, via the input/output module), and route the consumable components to a modular processing system. For example, in some embodiments, a plate includes one or more reagents or a plurality of pipette tips that are used by a sample processing module to process a sample. The consumable components can also be contained in a vial or other container.

The modular robotic system includes a backbone along the length of the system. One or more of the sample processing support system components, such as the main water supply conduit of the water supply system, the main power supply line of the power supply system, or the main liquid waste disposal conduit of the liquid waste disposal system can be disposed along the length of the modular robotic system. The plurality of sample processing modules can also be disposed along the length of the modular robotic system, for example along the perimeter of the backbone. The backbone also includes a bidirectional sample transportation track, which is configured to transport a sample between two or more nodes along the backbone. The two or more robotic arms are spaced along the backbone, and are each configured to transport a sample between at least one of the nodes and at least one of the sample processing modules.

The sample processing modules interface with one or more sample processing support systems, for example a water supply manifold, a power connector, or a liquid waste disposal manifold. The modular robotic system can modified, for example by adding a new sample processing module or replacing a first sample processing module with a second sample processing module, by joining or removing the sample processing module from the interface of the sample processing support system.

The modular robotic system can include two or more cells, each cell including a robotic arm. The cells are interconnected by a bidirectional plate transportation track, which includes a node within each cell that is accessible by the robotic arm within that cell, but not accessible by a robotic arm in any other cell. The cells include one or more modules around its perimeter, which are accessible by the robotic arm of that cell, but may not be accessible by the robotic arm of any adjacent cell. One or more support systems (e.g., a water supply system, a power supply system, a compressed gas system, a vacuum system, a data network, and/or a liquid waste disposal system) can run along the length of the modular robotic system, which can supply infrastructure to each of the cells within the robotic system. The modular robot support systems (e.g., the vacuum system, the compressed gas system, the liquid waste disposal system, and the water supply system) include one or more termini through which the system can be connected or expanded to an adjacent cell.

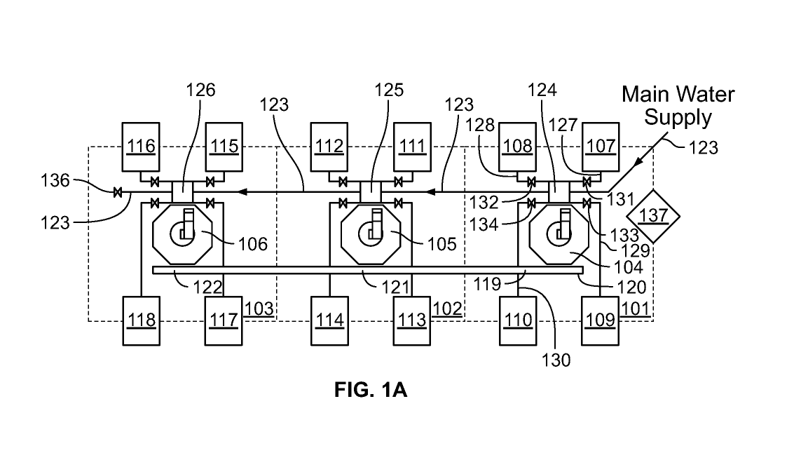

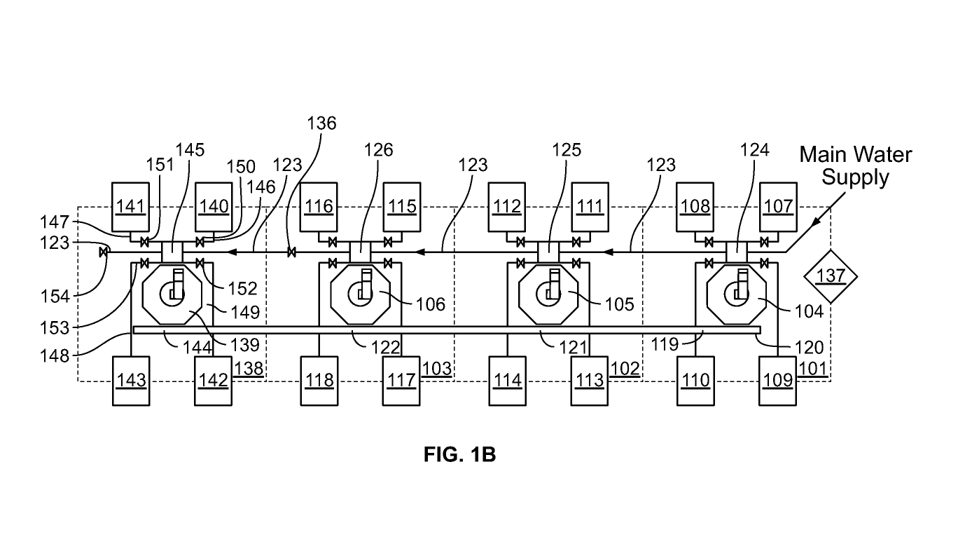

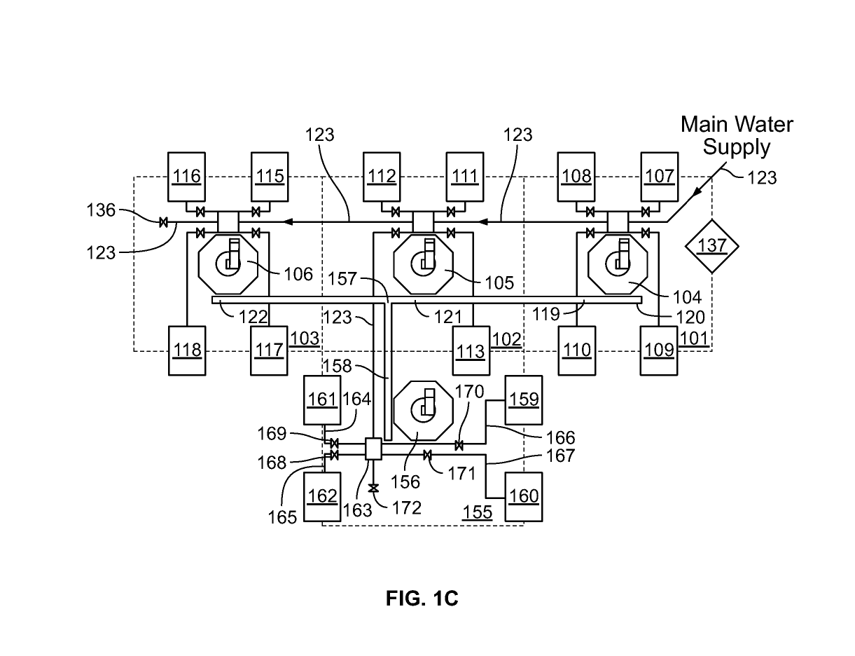

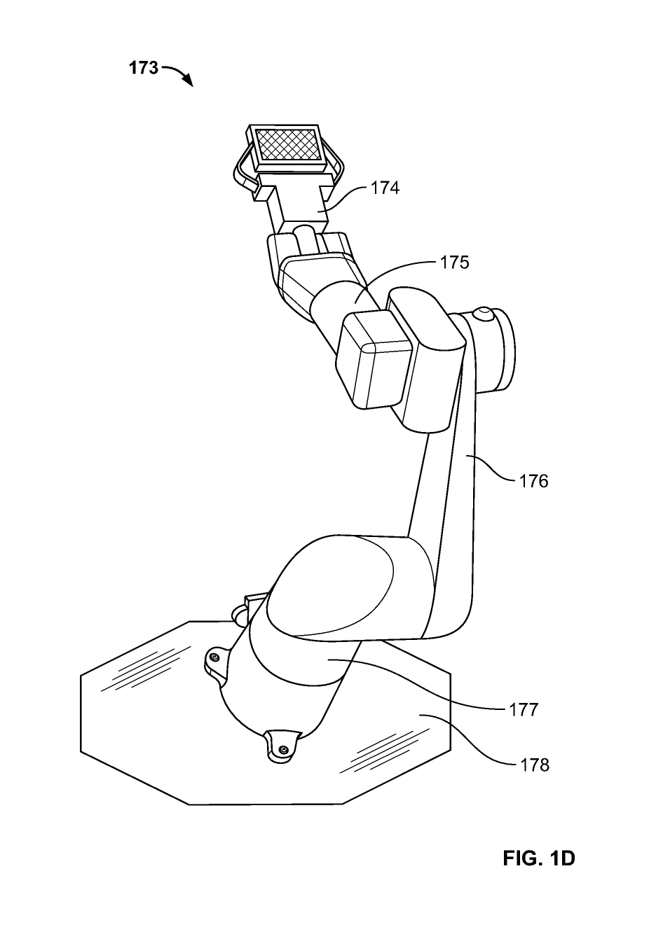

FIG. 1A illustrates an exemplary modular robotic system. The illustrated modular robotic system includes three cells (101, 102, and 103), which each include a robotic arm (104, 105, and 106). Along the perimeter of the first cell 101, there are four sample processing modules 107, 108, 109, and 110. Although the illustrated example shows four sample processing modules along the perimeter of the first cell 101, it is understood that one or more (such as two or more, three or more, or four or more) sample processing modules can be present along the perimeter of the first cell 101. Along the perimeter of the second cell 102, there are four sample processing modules 111, 112, 113, and 114. Although the illustrated example shows four sample processing modules along the perimeter of the second cell 102, it is understood that one or more (such as two or more, three or more, or four or more) sample processing modules can be present along the perimeter of the second cell 102. Along the perimeter of the third cell 103, there are four sample processing modules 115, 116, 117, and 118. Although the illustrated example shows four sample processing modules along the perimeter of the third cell 103, it is understood that one or more (such as two or more, three or more, or four or more) sample processing modules can be present along the perimeter of the third cell 103. A bidirectional plate transportation track 119 interconnects the first cell 101, the second cell 102, and the third cell. Along the bidirectional plate transportation track 119, there is a first node 120 within the first cell 101, a second node 121 within the second cell 102, and a third node 122 within the third cell. The first robotic arm 104 within the first cell 101 can access the sample processing modules 107, 108, 109, and 110, along with the first node 120. The sample processing modules and nodes within the second cell 102 or the third cell 103 are inaccessible to the first robotic arm 104.

One or more support systems can interconnect the cells of the modular robotic system. FIG. 1A illustrates a water supply system interconnecting the cells as an example, but it is understood that the liquid waste disposal system, the vacuum system, and/or the compressed gas system can also interconnect the cells of the modular robotic system, as further detailed herein. The water supply system includes a main water supply conduit 123, which connects water supply manifolds 124, 125, and 126 to a main water supply. In the illustrated example, each cell includes a separate water supply manifold. Water supply manifold 124 is the first cell 101 is connected to sample processing modules 107, 108, 109, and 110 by conduits 127, 128, 129, and 130. A valve 131, 132, 133, or 134 is disposed along the conduit 127, 128, 129, or 130 between the sample processing module 107, 108, 109, or 110 and the water supply manifold 124. The water supply manifold 124 is connected to water supply manifold 125 by a segment of the main water supply conduit 123, and the water supply manifold 125 is connected to water supply manifold 126 by another segment of the main water supply conduit 123. Water supply manifold 125 is connected to the sample processing modules along the perimeter of the second cell 102 and water supply manifold 126 is connected to the sample processing modules along the perimeter of the third cell 103 in a similar manner to how the water supply manifold 124 is connected to the sample processing modules along the perimeter of the first cell 101. The main water supply conduit 123 continues past water supply manifold 126 and terminates at a terminus 136. In the embodiment illustrated in FIG. 1A, terminus 136 is a valve.

The modular robotic system illustrated in FIG. 1A also includes an input/output module 137 along the perimeter of the first cell 101, and is accessible by the first robotic arm 104. Although the input/output module is illustrated along the perimeter of the first cell 101, the input/output module, if present in the modular robotic system at all, can be located along the perimeter of any cell.

The modular robotic system illustrated in FIG. 1A can be expanded, as illustrated in FIG. 1B or FIG. 1C. One or more additional robotic arms, an extension of the bidirectional sample transportation track, or one or more additional sample processing modules can also be added. The sample processing support systems includes a terminus (e.g., a main water supply conduit terminus, a terminal power connector, or a main liquid waste disposal conduit terminus), and an extension can be attached to the sample processing support system to expand the system. For example, a main water supply conduit extension can be attached to the main water supply conduit terminus to expand the water supply system. In some embodiments, for example the water supply system or the liquid waste disposal system, the terminus can include a valve, which can be opened after the extension is attached. Extension of the modular robotic system need not be linear, but can include a junction in the backbone.

As illustrated in FIG. 1B, a fourth cell 138 can be added to the modular robotic system adjacent to the third cell 103. The fourth cell includes a fourth robotic arm 139, and four sample processing modules 140, 141, 142, and 143 along the perimeter of the fourth cell 138. Although the illustrated example shows four sample processing modules along the perimeter of the fourth cell 138, it is understood that one or more (such as two or more, three or more, or four or more) sample processing modules can be present along the perimeter of the fourth cell 138. The bidirectional plate transportation track 119 can also be extended to provide a fourth node 144 for the fourth cell 138. Optionally (not illustrated in FIG. 1B), a second bidirectional plate transportation track can be added above the first bidirectional plate transportation track, below the first bidirectional plate transportation track, adjacent to the first bidirectional plate transportation track, or elsewhere instead of or in addition to expanding the first bidirectional plate transportation track. The support system can also be expanded to provide infrastructure for the fourth cell. As illustrated in FIG. 1B, the water supply system is expanded from the previous terminus 136. The main water supply conduit 123 is extended from the previous terminus 136 to a fourth water supply manifold 145. The fourth water supply manifold 145 is connected to sample processing modules 140, 141, 142, and 143 by conduits 146, 147, 148, and 149, which include valves 150, 151, 152, and 153. The main water supply conduit 123 can further extend from the fourth water supply manifold 145 to a terminus 154. In the illustrated example, the terminus 154 is a valve.

FIG. 1C illustrates an expanded modular robotic system with a non-linear topography. In the modular robotic system illustrated in FIG. 1C, the fourth cell 155 is adjacent to the second cell 102. Sample processing module 111 illustrated in FIG. 1A was removed, and the conduit connecting the second water supply manifold 125 to the sample processing module 111 instead becomes a second branch of the main water supply conduit 123, which is used to provide water to the fourth cell 155. Alternatively, the second water supply manifold 125 could include a conduit with a terminus that is not connected to a sample processing module, and the main water supply conduit could be extended from the terminus. The fourth cell includes a fourth robotic arm 156, and the bidirectional plate transportation track 119 is branched at junction 157 to provide a fourth node 158 within the fourth cell 155. The fourth cell 155 includes sample processing modules 159, 160, 161, and 162. The main water supply conduit 123 connects to water supply manifold 163, which is connected to the sample processing modules via conduits 164, 165, 166, and 167, which include valves 168, 169, 170, and 171. The main water supply conduit 123 can be extended from the water supply manifold 163 to an additional terminus 172, which can be used to further extend the water supply system to another cell.

FIG. 1D illustrates an angled view of a robotic arm 173. As depicted in FIG. 1D, robotic arm 173 includes a plate handling portion 174, a first solid section 175, a second solid section 176, a third solid section 177, and a robotic arm base 178. In some embodiments, plate handling portion 174 is connected to the first solid section 175. In some embodiments, first solid section 175 is connected at one end to plate handling portion 174, and is connected at another end to second solid section 176. In some embodiments, second solid section 176 is connected at one end to first solid section 175, and is connected at another end to third solid section 177. In some embodiments, third solid section 177 is connected at one end to second solid section 176, and is connected at another end to robotic arm base 178.

### Bidirectional Plate Transportation Track

The bidirectional plate transportation track allows for transportation of plates (such as sample plates or consumable plates) between cells of the modular robotic system. Each cell includes a robotic arm that can remove a plate from or place a plate on a node on the bidirectional plate transportation track. Once a plate is at a node on the bidirectional plate transportation track, the bidirectional plate transportation track can transport the plate to any other node on that track. The modular robotic system can include one or more (such as two or more, three or more, four or more, five or more, or six or more) bidirectional plate transportation tracks, which can provide additional nodes for a given cell. When the modular robotic system includes a plurality of plate transportation tracks, the tracks can be positioned above/below each other, adjacent to one another, or on either side of the robotic arm.

In some embodiments, the bidirectional plate transportation track includes a stationary track and a moveable component. The bidirectional plate transportation track can receive information to position the movable component to a node. A robotic arm can then place a plate on the movable component at the node, and the movable component can transport the plate to a second node along the plate transportation track. The bidirectional plate transportation track can be operated using an automation system, as described herein, which can route the plate based on defined workflow process and/or real-time workload of sample processing modules (for a sample plate) or based on consumable inventory levels of the sample processing modules (for a consumable plate).

### Input/Output Module

In some embodiments, the modular robotic system includes one or more input/output modules. The input/output module allows plates to be safely placed in or removed from the modular robotic system without suspending operation of the modular robotic system or any component of the modular robotic system. In some embodiments, a given cell includes two or more input/output modules. In some embodiments, a given cell does not include an input/output module. In some embodiments, the input/output module is configured to receive one or more plates from a user, and the one or more plates can be routed within the modular robotic system by a robotic arm. In some embodiments, the input/output module is configured to receive one or more plates from a robotic arm. In some embodiments, the input/output module can hold 1 or more, 2 or more 5 or more, 10 or more, 25 or more, 50 or more, or 100 or more plates.

The plates inputted into the modular robotic system can include a barcode or other identifier. The plate can be placed on the input/output module and identified (for example, by scanning the barcode). Stateful data or a defined workflow process assigned to the plate, which can be stored in a database, can be accessed, and the plate can be routed to a location within the modular robotic system based on the stateful data and/or defined workflow process. Plates can also be summoned by user to remove the plate from the modular robotic system. For example, a user can input a plate identifier into a computer system. The computer system can determine the location of the plate with that plate identifier based on the stateful data of that plate. The computer system can then route the plate to the input/output module, where it can be removed by the user.

The input/output module is disposed along the perimeter of a cell of the modular robotic system, and can be accessed by the robotic arm associated with that cell. In some embodiments, the input/output module includes one or more trays, which can serve as input trays, output trays, or combination trays (i.e. for input and output). In some embodiments, the input/output module includes an input button or switch, which can be activated by a user to alert the system of a plate to be inputted into the system. Upon receiving an input signal, the modular robotic system can route the plate to a location within the modular robotic system based on stateful data and/or a defined workflow process for the plate. A robotic arm can remove the plate from the input/output module and route the plate to a sample processing module within the cell, a node on the bidirectional plate transportation track, or a holding nest.

A plate can be summoned to the output nest by identifying a plate in a computer system. The computer system identifies the location of the plate within the modular robotic system and sends movement data to the robotic arm of the cell that contains the plate. If the plate is in the same cell as the input/output module, the robotic arm can route the plate to the input/output module. If the plate is in a cell other than the cell having the input/output module, the robotic arm can route the plate to a node on a bidirectional track, and the plate can be transported using the bidirectional track to a node within a second cell comprising the input/output module. A robotic arm within the second cell can then route the plate to the input/output module.

As a robotic arm can retrieve plates from or place plates on the input/output module, and a user can retrieve plates from or place plates on the input/output module, in some embodiments the input/output module is equipped with a safety feature to prevent a collision between a user and a robotic arm. In some embodiments, a first light curtain is placed on one side of the input/output module and a second light curtain is placed on the opposite side of the input/output module. The light curtain is penetrated by the robotic arm when the robotic arm is routing a plate to or from the input/output module, and the second light curtain is penetrated by the user when the user is placing a plate on or retrieving a plate from the input/output module. When both light curtains are penetrated, motion of the robotic arm is suspended, which can avoid a collision between the robotic arm and the user.

In some embodiments, the modular robotic system includes a plate input/out module comprising a plate identifier configured to identify a plate or a type of plate; a plate nest, wherein at least one of the robotic arms is configured to retrieve a plate from the plate nest or transport a plate to the plate nest; and an input signaler configured to submit a request to a computer system, which operates the robotic arm to retrieve the plate from the plate nest. In some embodiments, the plate nest is positioned between a first light curtain and a second light curtain, and the first light curtain is positioned between the plate nest and the robotic arm, wherein simultaneous penetration of the first light curtain and the second light curtain suspends operation of the robotic arm. In some embodiments, in response to the computer system receiving a user request for an identified sample or an identified plate, the robotic arm is operable to retrieve the identified sample or the identified plate and position the identified sample or the identified plate within the plate nest of the input/output module.

In some embodiments, the modular robotic system includes a plate loading module. The plate loading module can be used to load a plurality of plates into the modular robotic system without the need to individual signal the computer system of a plate input. In some embodiments, the loading module is configured to determine how many plates of a particular plate type are in the plate loading module, for example, based on the height of a plate stack or a weight of a plate stack.

In some embodiments, the input/output module includes a temperature controlled compartment, which can hold one or more plates. A robotic arm can retrieve a plate or to place a plate within the compartment. Samples may be temperature sensitive, for example, and sample plates can be stored within the temperature controlled compartment. In some embodiments, the temperature controlled compartment is held at a temperature of about 15° C. or lower (such as about 10° C. or lower, about 4° C. or lower, about 0° C. or lower, about −10° C. or lower, or about −20° C. or lower). In some embodiments, the temperature controlled compartment is held at an elevated temperature, such as above 15° C. or lower (such as between 15° C. and about 100° C. or lower, between 20° C. and about 65° C., or between about 30° C. and about 40° C.). The temperature controlled compartment can optionally be used for temporary storage or incubation of one or more plates (i.e., as a holding nest). For example, in some embodiments, a sample is processed by a processing module, and the plate containing the sample is routed to the temperature controlled compartment for a period of time, and is then routed to a second sample processing module.

One or more of the input/output modules may be configured only for plate input into the modular robotic system. The module can accept one or more plates (for example, one or more stacks of plates), and a robotic arm can receive a plate from the module. The robotic arm may receive the plate from the module on an as-needed basis, routing the plate to a destination within the modular robotic system.

In some embodiments, one or more input/output modules are configured only for plate output. For example, used sample plates or consumable plates may be disposed of in a waste container. The modular robotic systems may include different waste containers to receive different types of waste. For example, one or more of the input/output modules may be a waste container configured to receive hazardous waste, non-hazardous waste, wet waste, or dry waste. In some embodiments, one or more of the waste containers receive clean or reusable waste, such as plate lids.

### Sample Processing Modules

The sample processing modules are configured to receive a sample or sample plate from a robotic arm based on stateful data and the defined workflow process associated with the sample. The sample processing module can process the sample, and a robotic arm can retrieve the sample or sample plate form the sample processing module after completion of the sample processing. In some embodiments, a sample processing module transmits a signal to a computer system indicating that the sample has been received or the sample has been processed (or that one or more sample processing steps is complete). Upon receipt of the signal that the sample has been processed, the computer system can send instructions to the robotic arm to retrieve the sample from the sample processing module.

In some embodiments, the plurality of sample processing modules includes a nucleic acid (such as DNA or RNA) extraction module. The nucleic acid extraction module can receive a sample plate or sample that contains a patient sample (such as blood, saliva, or plasma) and isolates the nucleic acid in the sample. This can be done, for example, by adding one or more reagents to the sample, such as a lysis buffer, nucleic acid binding beads (which can be magnetic), a wash buffer, an elution buffer, water, or one or more other buffers. Nucleic acid extraction may also include a mixing step or an incubation step. After extraction of the nucleic acid, the completed processing step can be recorded by the computer system in the stateful data and the sample or sample plate can be transported to a second sample processing module according to the stateful data and the defined workflow process.

The plurality of sample processing modules can include a module for forming a nucleic acid library. For example, the sample processing module can received a sample or sample plate from a robotic arm after the sample has been processed by a nucleic acid extraction module, and processes the sample to attach sequencing adapters to the nucleic acid molecules. Formation of the nucleic acid library can include combining the sample with one or more reagents (such as buffers or enzymes), one or more adapter libraries (comprising adapters, which can optionally include a sample index molecular barcode, a specific nucleic acid sequence present in the sequencing adapter that can be used to identify the sequencing library of origin), or water. Formation of nucleic acid molecule may also include a mixing step (wherein the sample processing module comprises a mixer) or an incubation step (wherein the sample processing module optionally comprises an incubator, such as a heating block incubator). After formation of the nucleic acid sequencing library, the completed processing step can be recorded by the computer system in the stateful data and the sample or sample plate can be transported to an additional sample processing module, identified as processed by the processing module, and retained by the sample processing module or transported to an output bay or an input/output module of the modular robotic system, according to the stateful data and the defined workflow process.

In some embodiments, the sample processing modules can perform one or more pipetting functions (e.g., aspirating, dispensing, or mixing of liquids), shaking functions, heating functions, chilling functions, spinning functions (e.g., centrifugation), labeling functions (e.g., applying a barcode to a plate), sonicating functions, imaging functions, DNA quantization functions, applying or removing a heat seal, or applying or removing a plate lid.

The plurality of sample processing modules can also include a module for obtaining sample data. For example, the sample processing module can quantify an amount of nucleic acids in the sample, perform a real-time PCR assay, collect sample images, or a perform any other suitable assay step. Data collected from the sample can be sent to the computer system, which can be analyzed, for example, in the analytics results managements system (ARMS).

In some embodiments, one or more sample processing modules can combine the features described above. For example, in some embodiments, a single sample processing module can both extract nucleic acids and prepare a nucleic acid sequencing library.

Some or all of the sample processing modules in the modular robotic system can include specialized equipment for processing samples. Specialized equipment can include, a mixer, an incubator, a thermal cycler (i.e., a PCR machine), a pipette system (e.g., an automated multi-channel pipette), one or more liquid handlers (e.g., a liquid dispenser or a liquid aspirator), or one or more reagent troughs.

One or more of the sample processing modules can use reagents or consumables to process the samples. In some embodiments, one or more reagents (such as buffers, sequencing adapter libraries, or capture probe libraries) are contained in a reagent plate (which may be a multi-well reagent plate). The multi-well reagent plate may be useful, for example, when sample processing includes the use of several different reagents or when several samples within a sample plate are processed using different reagents. The contents of each well of the reagent plate (such as volume and type of reagent) can be reflected in a database, and the database can be updated when reagent is withdrawn from the plate. The reagent plate can be received by the sample processing module in a similar manner as the sample or sample plate. For example, the reagent plate can be received by from a robotic arm. The reagent plate can remain at the sample processing module, or it can optionally be transported to a second sample processing module (such as a redundant sample processing module). For example, a second sample processing module can submit a request for the reagent plate to the computer system, and the computer system can send instructions to a robotic arm to retrieve the reagent plate from the first sample processing module, and the reagent plate can then be transported to the second sample processing module. In some embodiments, the reagent plate is inputted into the modular robotic system using the input/output module or a plate loading module. In some embodiments, the reagent plate, once used or emptied (or emptied below a predetermined threshold as monitored by the computer system) is transported to an output bay or the input/output module of the modular robotic system.

Consumables, such as disposable pipette tips (which can be used by the pipette system) or sample tubes, can also be received by the sample processing module. The consumable may be arranged in a plate, which allows for easy transportation throughout the modular robotic system. A plate comprising a consumable can be referred to as a “consumable plate” (although the plate itself may be reusable). In some embodiments, a sample is transferred from a sample plate to a consumable plate (for example a consumable plate containing sample tubes), after which the consumable plate can be referred to as the sample plate for purposes of the stateful data and the defined workflow process. A sample processing module can receive a consumable plate from a robotic arm. The consumable plate may be inputted into the modular robotic system using the input/output module or a plate loading module. The contents of the consumable plate can be reflected in a database, and the database can be updated when a consumable from the plate is used or a sample is transferred to the consumable plate. The consumable plate can remain at the sample processing module, or it can optionally be transported to a second sample processing module (such as a redundant sample processing module). For example, a second sample processing module can submit a request for the consumable plate to the computer system, and the computer system can send instructions to a robotic arm to retrieve the consumable plate from the first sample processing module, and the reagent plate can then be transported to the second sample processing module. In some embodiments, the consumable plate, once used or emptied (or emptied below a predetermined threshold as monitored by the computer system) is transported to an output bay or the input/output module of the modular robotic system.

### Vacuum System

In some embodiments, the modular robotic system includes a vacuum system, which can supply vacuum to one or more sample processing modules. The vacuum system includes a main vacuum conduit connected to a vacuum source (such as a pump) and one or more vacuum manifolds. In some embodiments, each cell of the modular robotic system includes a vacuum manifold, although it is contemplated that a vacuum manifold could provide vacuum to two or more cells. When the modular robotic system includes two or more vacuum manifolds, the main vacuum conduit can connect the vacuum source to the first vacuum manifold, and the main vacuum conduit can continue from the first vacuum manifold to a second vacuum manifold. The vacuum system can also include a terminus at the end of the main vacuum conduit, which can be a valve or cap (which may be threaded). The main vacuum conduit can be extended from the terminus to extend the modular robotic system and provide vacuum to another cell. The vacuum system optionally includes a pressure gauge (e.g., a pressure transmitter) or pressure regulator disposed along the main vacuum conduit. The pressure gauge or pressure regulator can send or receive pressure information to or from the automation system.

The modular robotic system optionally includes a vacuum modular integration unit, which may be part of the vacuum system or part of the sample processing module, which is disposed between the vacuum manifold and the functional components of the sample processing module. The vacuum modular integration unit can include a filter, a pressure gauge (e.g., a pressure transmitter) or a pressure regulator, and/or an overflow container. The filter limits aerosolized debris from entering the vacuum source, and the overflow container can limit liquids from the sample processing module from entering the vacuum source. The pressure gauge and/or pressure regulator ensures proper function of the vacuum in the sample processing module.

The vacuum system can include a plurality of valves disposed between the sample processing modules connected to the vacuum system and the one or more vacuum manifolds, which may be part of the vacuum module integration unit. The valve can be operable (for example, by the automation system) selectively open only when vacuum to another sample processing module from the vacuum system is prevented. Simultaneous use of the vacuum system by too many sample processing modules may result in an unreliable decrease in vacuum pressure. This fluctuation in vacuum pressure can be minimized by restricting the number of sample processing systems that can simultaneously access vacuum system by controlling the valve. In some embodiments, only three or fewer, or only two or fewer sample processing module may simultaneously accesses the vacuum from the vacuum system. In some embodiments, only one sample processing module at any time can access the vacuum from the vacuum system. The valve can be operable to selectively open according to a vacuum system prioritization schedule, which can be managed by the automation system.

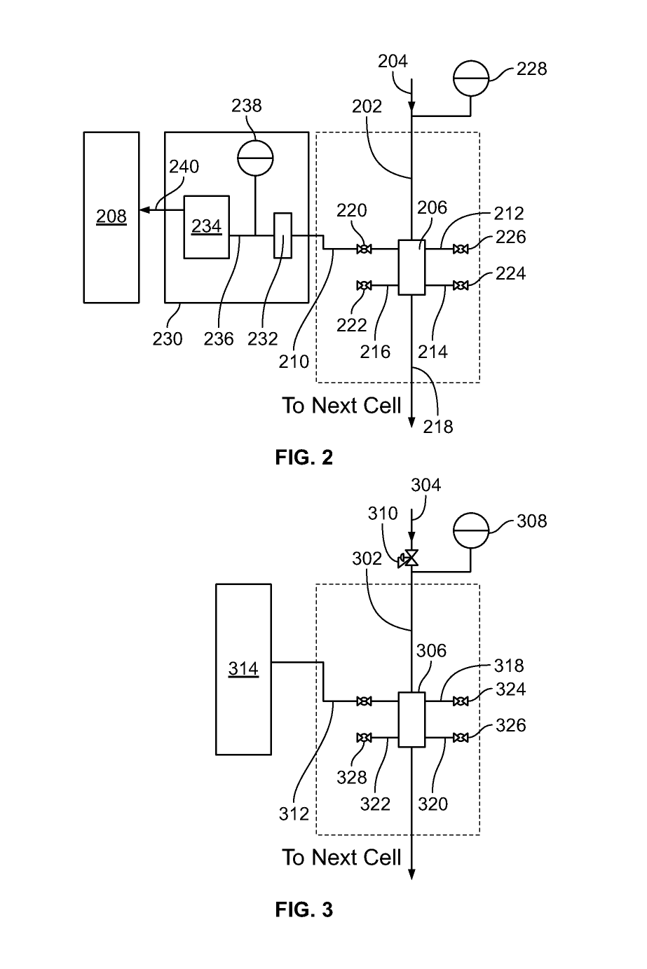

FIG. 2 illustrates a vacuum system for a cell of a modular robotic system. The vacuum system includes a main vacuum conduit 202, which transmits negative pressure from the vacuum source 204 (e.g., a house vacuum or pump). The main vacuum conduit 202 is connected to a vacuum manifold 206. The vacuum manifold 206 is connected to a sample processing module 208 by conduit 210 to provide vacuum to the sample processing modules. The vacuum manifold 206 also includes conduits 212, 214, 216, and 218 extending from the manifold. Valves 220, 222, 224, and 226 are disposed along conduits 210, 212, 214, and 216. The valve can be closed when a sample processing module is not attached to the vacuum manifold (e.g., valves 222, 224, and 226), and open when connected to a sample processing module (e.g., valve 220). Conduit 218 is an extension of the main vacuum conduit 202, and continues to an adjacent cell. If no adjacent cell is connected to the main vacuum conduit, the main vacuum conduit 202 can include a terminus, such as a valve or a cap (which may be threaded). A pressure gauge (e.g., a pressure transmitter 228) or a pressure regulator is optionally disposed along the main vacuum conduit 202, which can be used to monitor the vacuum pressure in the vacuum system.

FIG. 2 further illustrates the optional vacuum module integration unit 230. Conduit 210 is fluidly connected to filter 232. The filter 232 is fluidly connected to an overflow container 234 by conduit 236. A pressure gauge (e.g., a pressure transmitter 238) or a pressure regulator is disposed along conduit 236. The overflow container 236 is fluidly connected to the sample processing module 208 by conduit 240.

In some embodiments, the modular robotic system comprises a vacuum system connected to two or more sample processing module, which may be in the same cell or in different cells of the modular robotic system, the vacuum system comprising a main vacuum conduit and one or more vacuum manifolds. In some embodiments, each cell of the modular robotic system comprises a vacuum manifold. In some embodiments the vacuum system further comprises a vacuum system terminus, such as a valve or a cap, which can be used to extend the vacuum system, and may be disposed at the end of the main vacuum conduit. In some embodiments, the vacuum system further comprises a valve disposed between one of the one or more vacuum and one of the two or more sample processing modules. In some embodiments, the valve is operable to selectively open only when vacuum to any other sample processing module from the vacuum system is prevented. In some embodiments, the valve is operable to selectively open according to a vacuum system prioritization schedule.

### Compressed Gas System

In some embodiments, the modular robotic system includes a compressed gas system, which can supply compressed gas to one or more sample processing modules. The compressed gas may be, for example, air or an inert gas (such as nitrogen). The compressed gas system includes a main compressed gas conduit, which is connected to a compressed gas source (such as a compressed gas tank or a pump) and one or more compressed gas manifolds. In some embodiments, each cell of the modular robotic system includes a compressed gas manifold, although it is contemplated that a compressed gas manifold can provide compressed gas to two or more cells. When the modular robotic system includes two or more compressed gas manifolds, the main compressed gas conduit can connect the compressed gas source to the first compressed gas manifold, and the main compressed gas conduit can continue from the first compressed gas manifold to a second compressed gas manifold. The compressed gas system can also include a terminus at the end of the main compressed gas conduit, which can be a valve or a cap (which may be threaded). The main compressed gas conduit can be extended from the terminus to extend the infrastructure of the modular robotic system and provide compressed gas to another cell. The compressed gas system optionally includes a pressure gauge (e.g., a pressure transmitter) and/or a pressure regulator disposed along the main compressed gas conduit. In some embodiments, the pressure gauge or pressure regulator can send or receive pressure information to or from the automation system.

The compressed gas manifold is fluidly connected to one or more sample processing modules by a conduit. A valve is disposed along the conduit connecting the compressed gas manifold to the sample processing module, which can be opened when the sample processing module is connected to the compressed gas manifold, or closed when the conduit is not connected to a sample processing module.

The compressed gas system can include a plurality of valves disposed between the sample processing modules connected to the compressed gas system and the one or more compressed gas manifolds. The valve can be operable (for example, by the automation system) selectively open only when compressed gas to another sample processing module from the vacuum system is prevented. Simultaneous use of the compressed gas system by too many sample processing modules may result in an undesirable fluctuation in gas pressure. This fluctuation in pressure can be minimized by restricting the number of sample processing systems that can simultaneously access compressed gas system by controlling the valve. In some embodiments, only three or fewer, or only two or fewer sample processing module may simultaneously accesses the compressed gas from the compressed gas system. In some embodiments, only one sample processing module at any time can access the compressed gas from the compressed gas system. The valve can be operable to selectively open according to a compressed gas system prioritization schedule, which can be managed by the automation system.

FIG. 3 illustrates a compressed gas system for a cell of a modular robotic system. The compressed gas system includes a main compressed gas conduit 302, which is fluidly connected to a compressed gas source 304 (such as a pump or a compressed gas tank). The main compressed gas conduit 302 is fluidly connected to a compressed gas manifold 306 for the cell. An optional pressure gauge 308 (e.g., a pressure transmitter) and/or a pressure regulator 310 is disposed along the main compressed gas conduit 302. The pressure gauge 308 and the pressure regulator 310, if included, need not be included for the each cell and a single gauge 308 or single pressure regulator 310 can be used for the entire compressed gas system. The compressed gas manifold 306 is fluidly connected to a plurality of additional conduits. In some embodiments, one of the conduits extending from the compressed gas manifold 306 is an extension of the main compressed gas conduit 302, which can include a terminus (such as a valve or a cap, which may be threaded) or may extend to an adjacent cell. The compressed gas manifold 306 shown in the compression gas system illustrated in FIG. 3 is fluidly connected to conduit 312, which is fluidly connected to sample processing module 314. A valve 316 is disposed along conduit 312 and is open when the compressed gas system is connected to the sample processing module 314. The compressed gas manifold 306 is also connected to conduits 318, 320, and 322, each of which have a terminus (illustrated as a valve 324, 326, or 328, but any of the termini could optionally be a valve or a cap, which may be threaded). Any of the termini could optionally be connected to a further sample processing module along the perimeter of the cell, or could be used to extend the compressed gas system (i.e., as an extension of the main compressed gas conduit) to provide compressed gas to an adjacent cell.

In some embodiment, the modular robotic system comprises a compressed gas system connected to two or more sample processing modules, which may be in the same cell or in different cells, the compressed gas system comprising a main compressed gas supply conduit and one or more compressed gas manifolds. In some embodiments, the compressed gas system comprises a compressed gas system terminus, such as a valve or a cap, which may be used to connect or extend the compressed gas system to an adjacent cell, and which may be located at the end of the main compressed gas supply conduit. In some embodiments, the compressed gas system further comprises a valve disposed between one of the sample processing modules and one of the compressed gas manifolds. The valve may be operable to electively open only when compressed gas to any other sample processing module from the compressed gas system is prevented. In some embodiments, the valve is operable to selectively open according to a compressed gas system prioritization schedule.

### Liquid Waste Disposal System

In some embodiments, the modular robotic system described herein includes a liquid waste disposal system, which can receive liquid waste generated by one or more sample processing modules and transport the liquid waste to a sewer system or liquid waste container. The sample processing modules generate liquid waste from, for example spent reagents or biohazardous waste from the samples, which is periodically or continuously removed from the sample processing module to allow for continuous operation. The liquid waste can be manually removed from the sample processing modules; however such manual removal risks spills and/or contamination, or may require temporary suspension of the sample processing module. The liquid waste disposal system described herein promotes continuous operation of the modular robotic system.

The liquid waste disposal system includes a main liquid waste conduit and one or more liquid waste disposal manifolds. The main liquid waste conduit is connected at one end to a sewer system or a liquid waste container. In some embodiments, each cell of the modular robotic system includes a liquid waste manifold, although it is contemplated that a liquid waste manifold could be interconnected to two or more cells. The main liquid waste conduit is connected to the liquid waste manifold, and can continue to extend beyond the liquid waste manifold to a terminus or to a second liquid waste manifold at an adjacent cell. The terminus or the main liquid waste conduit can be a valve or a cap (which may be threaded). The main liquid waste conduit can be extended from the terminus, for example to provide the liquid waste disposal system to an additional cell of the modular robotic system. The liquid waste manifold can also be connected to one or more sample processing modules by a conduit, which may include a valve disposed along the conduit.

In some embodiments, a liquid waste module integration unit connects the liquid waste manifold to the sample processing module (or the liquid waste module integration unit may be part of the sample processing module itself). A liquid waste module integration unit is provided for each sample processing module connected to the liquid waste management system. The liquid waste module integration unit includes a container and a pump. Liquid waste flows from the sample processing module to into the container via a conduit. The liquid waste container is connected to the pump by a second conduit, which is connected to the liquid waste manifold by a third conduit. Liquid waste accumulates in the container until a signal is received by the module integration unit to dispose of the liquid waste. Liquid waste, such as biohazardous liquid waste, may accumulate in the container for treatment, which may require an incubation period prior to disposal. Upon receiving a signal, the pump operates to pump the liquid waste from the container and into the liquid waste manifold. Optionally, the module integration unit includes a control valve which opens when the pump is in operation to control flow of the liquid waste into the liquid waste disposal system. In some embodiments, the control valve is located along the conduit connecting the modular integration unit and the waste manifold. The container can include a level sensor (such as a scale, conductive sensor, mechanical sensor, or any other level sensor), which can measure the volume of the liquid waste in the container. The module integration unit can also include a pressure gauge (e.g., a pressure transmitter) or pressure regulator disposed along conduit connecting the pump to the liquid waste manifold. Optionally, the modular integration unit includes a spill sensor, which can detect an overflow or spill from the container.

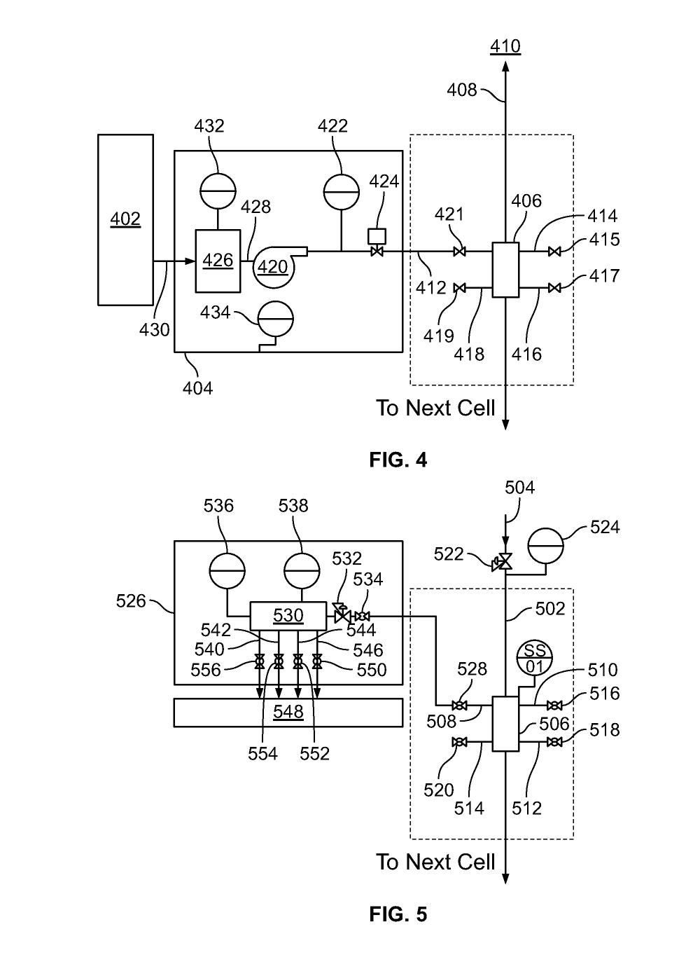

FIG. 4 illustrates a cell of a modular robotic system that includes a liquid waste disposal system connected to a sample processing module 402. A liquid waste disposal module integration unit 404 is disposed between the sample processing module 402 and a liquid waste manifold 406. The main liquid waste conduit 408 is connected to a drain 410 (or sewer or container), and to the liquid waste manifold 406. The main liquid waste conduit 408 continues to extend from the liquid waste manifold 406 to the adjacent cell, where it can join to a liquid waste manifold in that cell. The liquid waste manifold 406 includes additional attached conduits (conduit 412, conduit 414, conduit 416, and conduit 418 in the embodiment illustrated in FIG. 4). Conduit 412 is fluidly connected to the liquid waste module integration unit 404, which is attached to the sample processing module 402. Conduit 414, conduit 416, conduit 418 can each be connected to a terminus (such as a valve or a cap, which may be threaded), a sample processing module, or a liquid waste module integration unit (which is itself attached to sample processing module). In the example illustrated in FIG. 4, conduit 414 is connected to valve 415, conduit 416 is connected to valve 417, and conduit 418 is connected to valve 419. Along conduit 412 and disposed between the liquid waste manifold 406 and the liquid waste disposal module integration unit 404, there is an optional valve 421, which can be closed to disconnect the sample processing module from the liquid waste disposal system, if desired. Conduit 412 is fluidly connected to a pump 420. Disposed along conduit 412 there is a pressure transmitter 422 and a control valve 424. The pump is fluidly connected to a container 426 by conduit 428, which is fluidly connected to the sample processing module 402 by conduit 430. The container 426 include a level transmitter 432, which can detect the amount of liquid waste in the container 426, and can send the level of liquid waste in the container to a computer system. The modular integration unit 404 can be contained within a housing and include spill sensor 434. The spill sensor 434 can detect liquid waste that leaks from any component within the modular integration unit 404.

Optionally, the liquid waste disposal system is controlled to avoid overloading the liquid waste disposal system or a connected sewer system. During operation of the modular robotic system, liquid waste is disposed of through the liquid waste disposal system. If too much liquid waste is disposed of at the same time, the liquid waste system or sewer system could become overwhelmed, resulting in dangerous liquid waste backflow or overflow. To alleviate this risk, the liquid waste (which may be stored in the liquid waste containers) can be disposed of through the liquid waste system according to a liquid waste prioritization schedule. When the liquid waste prioritization schedule permits disposal of liquid waste from a liquid waste container (either in one of the sample processing modules or one of the liquid waste module integration unit), the pump in the liquid waste module integration unit is operated and/or the control valve is opened to allow the liquid waste to flow into the liquid waste manifold. The liquid waste can then flow through the main liquid waste conduit and to the drain, sewer or main liquid waste container.

In some embodiments, the liquid waste prioritization schedule limits the number of liquid waste containers from which liquid waste can simultaneously flow. In some embodiments, the liquid waste prioritization schedule allows liquid waste to flow from a single liquid waste container at a time. In some embodiments, the liquid waste prioritization schedule allows liquid waste to simultaneously flow from a maximum of two, three, four, five, or six liquid waste containers at a time. The liquid waste prioritization selects the liquid waste container from which liquid waste flows out of based on one or more factors, such as, but not limited to: fullness of the liquid waste container; rate of liquid waste generation by the associate sample processing module; time the liquid waste has incubated in the liquid waste container; and frequency of use of the associated sample processing module.

In some embodiments, the modular robotic system comprises a liquid waste disposal system connected to two or more sample processing, which may be in the same cell or in different cells, the liquid waste disposal system comprising a main liquid waste disposal conduit and done or more liquid waste disposal manifolds. In some embodiments, each cell has its own liquid waste disposal manifold. In some embodiments, the liquid waste disposal system comprises a liquid waste disposal system terminus, such as a valve or a cap, which can be used to connect or extend the liquid waste disposal system to an adjacent cell, and which can be disposed at the end of the main liquid waste disposal conduit. In some embodiments, the liquid waste disposal system comprises a valve, pump, or regulator disposed between one of the one or more liquid waste disposal manifolds and one of the sample processing modules. The valve, pump or regulator may be operable to electively open or pump liquid waste only when the flow of liquid waste from any other sample processing module is prevented. In some embodiments, the valve, pump, or regulator is operable to selectively open according to a liquid waste disposal system prioritization schedule.

### Water Supply System

In some embodiments, the modular robotic system described herein includes a water supply system, which can deliver water (such as filtered or deionized water) to one or more sample processing modules. The water supply system includes a main water supply conduit and one or more water supply manifolds. The main water supply conduit is connected to a water source and a water supply manifold. The main water supply conduit can be extended from the water supply manifold to an adjacent cell (where it can connect to a water supply manifold in that cell) or to a terminus (such as a valve or a cap, which may be threaded). The water supply system includes one or more conduits branching from the water supply manifold, which can be connected to a sample processing module, a water supply module integration unit (which may be part of the sample processing module) or a terminus (such as a valve or a cap, which may be threaded). When the conduit is connected to a sample processing module or a water supply module integration unit, a valve or threaded connector is optionally disposed along the conduit. The water supply system optionally includes a pressure gauge (e.g., a pressure transmitter) and/or a pressure regulator disposed along the main water supply conduit, preferably upstream of the first water supply manifold connected to the main water supply conduit. In some embodiments, a spill sensor is disposed on or adjacent to the water manifold, which is configured to detect water leaking from the water supply conduit.

The water supply module integration unit includes a water manifold, which is connected to the water supply manifold disposed along the main water supply conduit. One or more conduits can branch from the water manifold in the water supply module integration unit to connect to one or more components of the sample processing module (such as a dispenser). A valve can be disposed along the conduit connecting the water manifold in the water supply module integration unit to the component of the water supply module. The valve can be closed when no component is connected to the water manifold and opened when a component is connected, thereby allowing water to be supplied to the component. The water supply module integration unit can include a pressure gauge (e.g., a pressure transmitter) or pressure regulator, which monitors or controls the water pressure delivered to the water manifold within the water supply module integration unit. In some embodiments, the water supply modular integration unit includes a spill sensor, which is configured to detect water spilled with in the water supply modular integration unit.

FIG. 5 illustrates one embodiment of a water supply system for use with a modular robotic system. The water supply system includes a main water supply conduit 502, which is connected to a main water supply source 504 and a water supply manifold 506. The main water supply conduit 502 further extends from the water supply manifold 506 to an adjacent cell of the modular robotic system, where in can connect to an additional water supply manifold for that cell. In the illustrated embodiment, four conduits (conduit 508, 510, 512, and 514) branch from the water supply manifold 506. Conduit 510, conduit 512, and conduit 514 each connect to a terminus (valve 516, valve 518, and valve 520, in the illustrated embodiment). The terminus can be extended to an adjacent cell to provide an additional branch of the main water supply conduit 502, or can be connected to a sample processing module or water supply module integration unit. A pressure regulator 522 and a pressure transmitter 524 are disposed along the main water supply conduit 502 upstream of the main water supply conduit 502. The pressure regulator 522 is configured to control the water pressure in the main water supply conduit 502, and the pressure transmitter 524 is configured to send water pressure information to a computer system. Conduit 508 is fluidly connected to a water supply module integration unit 526, and a valve 528 is disposed along the conduit 508. The valve 528 can be closed to remove the water supply module integration unit 526, or opened when the water supply module integration unit 526 is connected. The conduit 508 connects to a second water manifold 530 within the water supply module integration unit 526. A pressure regulator 532 and a valve 534 are optionally disposed along the conduit 508 within the water supply module integration unit 526. The pressure regulator 532 is configured to control the water pressure entering the second water manifold 530. A pressure gauge 536 (e.g., a pressure transmitter) is disposed downstream of the pressure regulator 532, and is configured to measure and/or report water pressure information in the second water manifold 530. The pressure gauge can be disposed along the conduit 508 or on the second water manifold 530. The illustrated system further includes an optional spill sensor 538 within the water supply modular integration unit 526, which is configured to detect and/or report water leaking within the water supply module integration unit 526. Branching from the second water manifold 530 is a plurality of conduits (conduit 540, conduit 542, conduit 544, and conduit 546). One or more of the conduits can be connected to a component on the sample processing module 548. Valve 550, valve 552, valve 554, and valve 556 are disposed along or at the terminus of (conduit 540, conduit 542, conduit 544, and conduit 546), which can be opened when connected to a component of the sample processing module 548, or closed when not connected to a component of the sample processing module 548.

In some embodiments, the modular robotic system comprises a water supply system connected to one or more sample processing modules, which may be in the same cell or in different cells, the water supply system comprising a main supply conduit and one or more water supply manifolds. In some embodiments, each cell in the modular robotic system comprises a water supply manifold. In some embodiments, the water system supply system includes a water system supply terminus, such as a valve or a cap, which can be used to connect or extend the water supply terminus to an adjacent cell, and which may be disposed at the end of the water supply system. In some embodiments a valve and/or a pressure regulator is disposed between a water supply manifold and a sample processing module. In some embodiments, the water supply system comprises a flow sensor and/or a pressure regulator disposed along the main water supply conduit.

### Power Supply System

In some embodiments, the modular robotic system includes a power supply system configured to provide power and/or a data network connection to one or more sample processing modules. The power supply system includes a main power line (e.g., a building power line) connected to one or more main control panels. Each cell of the module robotic system can be associated with a separate main control panel, although it is contemplated that a single main control panel can be configured to provide power and/or a data network to two or more cells. The power line can provide three-phase power to the main control power. For example, the main power line can provide three-phase 208 VAC power to the main control panel. The main control panel can include a power distribution module (PDM), one or more circuit breakers (AC/DC), a transformer, and/or a direct current power supply (for example a 24 VDC power supply). The main control panel can output three-phase alternating current, single-phase alternating current (at one or more frequencies), and/or direct current, one or more of which may be connected to one or more sample processing modules or one or more modular integration units (which may be part of the sample processing module). For example, in some embodiments, the main control panel can output three-phase 208 VAC, single-phase 120 VAC, single-phase 240 VAC, and/or 24 VDC power, one or more of which may be connected to one or more sample processing modules or one or more modular integration units (which may be part of the sample processing module). The main control panel can optionally include an uninterruptible power supply, which can provide power to the cell in the event of a power interruption. The main control panel can also be configured to receive information from a data network (such as an Ethernet connection), and can include a managed network switch that distributes the data network to one or more sample processing modules and/or a power supply module integration unit.

A power supply module integration unit can receive power and/or data from the main control panel, and provide the power and/or data to a sample processing module. In some embodiments, the power supply module integration unit is configured to receive the three-phase alternating current, single-phase alternating current, and/or direct current power from the main control panel. In some embodiments, the power supply module integration unit is configured to receive the three-phase 208 VAC, single-phase 120 VAC, single-phase 240 VAC, and/or 24 VDC power from the main control panel. For example, in some embodiments, the power supply module integration until includes an AC power strip, which can receive 120 VAC power (or 240 VAC) from the main control panel. The sample processing module and/or one or more components of the sample processing module can plug into the AC power strip to receive the 120 VAC power (or 240 VAC). The power supply module integration unit can include a DC power distribution panel and/or DC power circuit breakers. The power supply module integration unit can receive the 24 VDC power from the main control panel, and the sample processing module and/or one or more components of the sample processing module can plug into the DC distribution panel to draw 24 VDC power. The power supply module integration unit can also include a data switch (e.g., an Ethernet switch), and optionally a serial (for example, a RS232 connection) to Ethernet converter, which can connect to the sample processing module and/or one or more components of the sample processing module. Optionally, the power supply module integration unit can be configured to supply three phase 208 VAC to one or more sample processing modules and/or one or more components of the sample processing module.

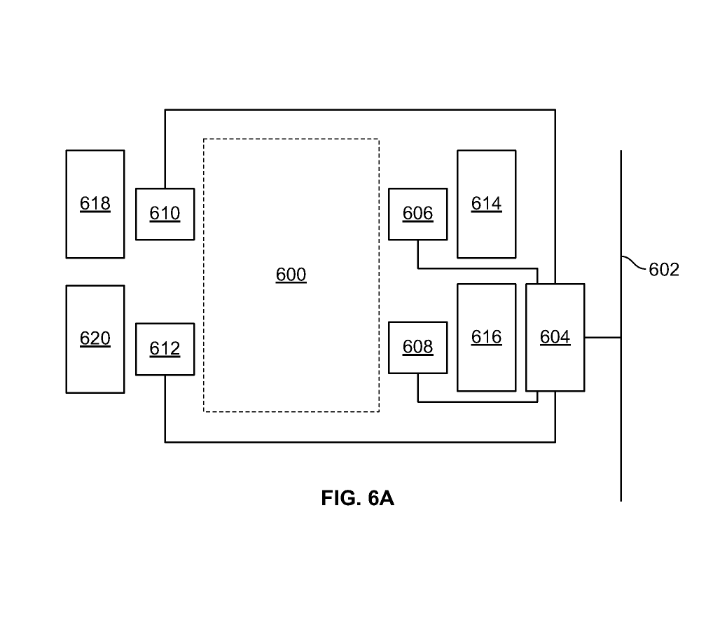

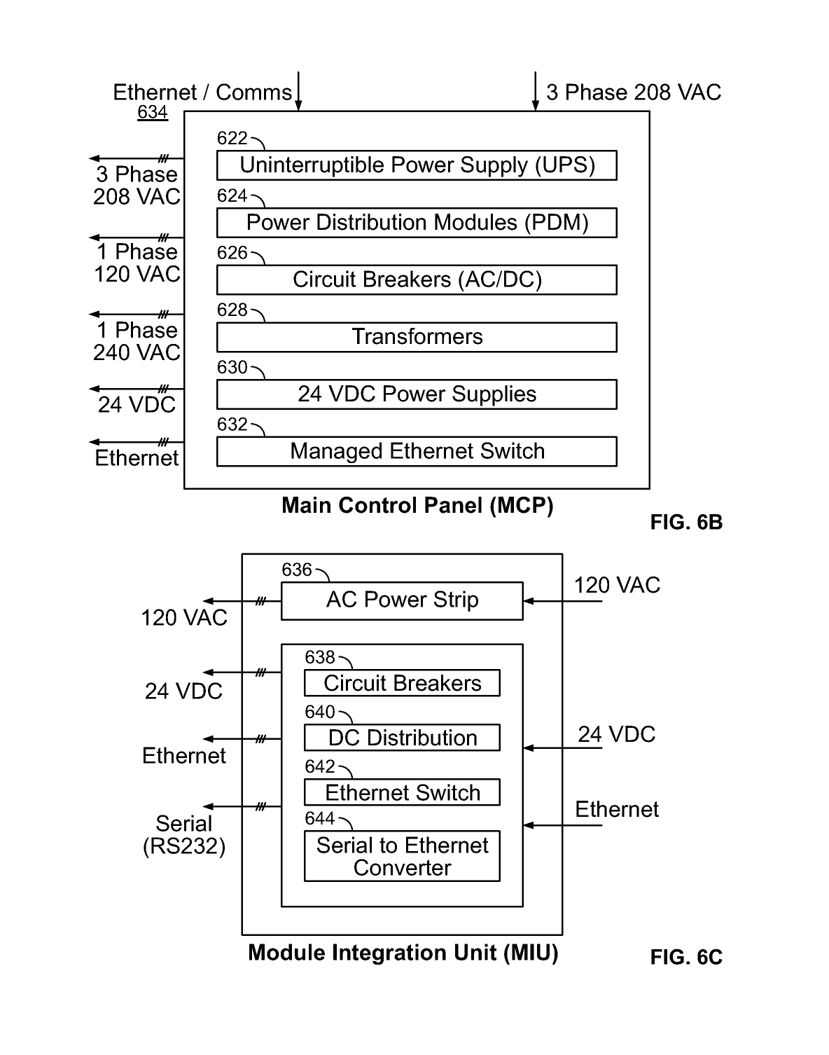

FIG. 6A illustrates one embodiment of a power supply system for a cell 600 of a modular robotic system. The power supply system includes a main power line 602 connected to a main control panel 604. Although not illustrated in FIG. 6A, the main control panel 604 can also be connected to a data network, either wirelessly or through a wired connection (such as an Ethernet connection or fiber optic connection). The main control panel 604 is connected to power supply module integration unit 606, power supply module integration unit 608, power supply module integration unit 610, and power supply module integration unit 612 to supply 120 VAC (or 240 VAC) and 24 VDC power. The main control panel 604 can also be connected to one or more of the power supply module integration units to provide the data network, for example by an Ethernet or fiber optic data connection. Power supply module integration unit 606 is connected to sample processing module 614 to supply power and/or the data network to the sample processing module. Power supply module integration unit 608 is similarly connected to sample processing module 616, power supply module integration unit 610 is similarly connected to sample processing module 618, and power supply module integration unit 612 is similarly connected to sample processing module 620.

An exemplary main control panel is illustrated in FIG. 6B. The illustrated main control panel includes an uninterruptible power supply (UPS) 622, a power distribution module (PDM) 624, one or more AC/DC circuit breakers 626, one or more transformers 628, one or more 24 VDC power supplies 630, an a managed Ethernet switch 632. The main control panel is configured to receive data from a data network 634, for example using an Ethernet connection and three phase 208 VAC power from a main power line. The main control panel is also configured to output one or more of three phase 208 VAC power, single phase 120 VAC power, single phase 240 VAC power, 24 VDC power, and/or the data network.

FIG. 6C illustrates an exemplary power supply modular integration unit. The illustrated power supply modular integration unit is configured to receive 120 VAC, 24 VDC, and data from a data network, which can be provided by the main control panel. The power supply modular integration unit includes an AC power strip 636, which is configured to receive the 120 VAC power and output 120 VAC power at a plurality of outputs. The power supply modular integration system further includes one or more circuit breakers 638, a DC distribution panel 640, a data network switch 642, and a serial to Ethernet converter 644.

In some embodiments, the modular robotic system includes one or more power supply systems connected to a main power supply line and one or more sample processing modules, which may be in the same cell or in different cells. In some embodiments, the power supply system comprises a transformer configured to receive power form the main power supply line and supply three-phase 208 VAC, single-phase 120 VAC, single phase 240 VAC, or 24 VDC power. In some embodiments, the power supply system includes a battery.

In some embodiments, the modular robotic system includes a data network configured to provide communication between one or more sample processing modules and a computer system, and may include one or more data switches. In some embodiments, the data network is configured to provide communication between the computer system and one or more of the liquid waste disposal system, the water supply system, the vacuum system, and/or the compressed gas system. The data network can be part of the power supply system or a separate system.

### Operation of the Modular Robotic System

Operation of the modular robotic system can be guided by an automation system. The automation system can provide management of the workflow processes, location of samples, location of plates (including sample plates and consumable plates), real-time workload of sample processing modules, and commands for moving the robotic arms in three-dimensional space.

The samples that enter the modular robotic system can have a defined workflow process. The workflow process indicates the steps for processing the sample using the sample processing modules, including the order of steps and order of sample processing modules that process the samples. In some embodiments, a sample plate containing samples is entered into the modular robotic system and all samples in that sample plate have the same workflow process. In some embodiments, the samples have different workflow processes (that is, one of the sample processing modules can reassign the samples contained within a sample plate to a new sample plate, or sample processing module may processes a portion of the samples in a given sample plate). The automation system may permit the deployment of a custom laboratory workflow processes. For example, the automation system may provide functionality for a user to create a graphical diagram to model different laboratory equipment and diagnostics, and may permit the user to customize the timing, decision-making, and other test variables of laboratory analytics. The automation system may further provide functionality to permit a user to define and/or deploy one or more workflow processes based on user-generated diagrams, and such workflow processes may be modified dynamically by the user. As a sample or plate progresses through a defined workflow process, the completed processing steps can be recorded as part of the sample and/or plate's stateful data.

The automation system may generate and send commands to the one or more robotics arms to allow the robotics arms to move in three-dimensional space, or generate and send commands to the bidirectional plate transportation track to transport a plate from a first node to a second node within the modular robotic system. Such commands may also permit the one or more robotics arms to interface with a pneumatics system to utilize pressurized air for grasping and releasing one or more plates. The commands can also provide movement information to a robotic arm and/or bidirectional plate transportation track to route or transport a plate to a location within the modular robotic system, such as a node on a plate transportation track, a sample processing module, a holding nest, and/or an input/output module.

The automated system can further include a lab tracker, which facilitates physical location management of the one or more robotic arms and/or plates (including sample plates and consumable plates). For example, the lab tracker may be configured as a database which stores positional information of all physical objects for a given point in time. When a plate is transported or routed within the modular robotic system, the location of the plate can be recorded as part of the stateful data of the sample and/or plate.

The automation system can further manage operation of the sample processing modules, for example by managing when the sample processing module is in use or when the sample processing module is available to process additional samples. Plates can be dynamically routed to a particular sample processing module based on the real-time load of the sample processing module. Managing operation of the sample processing modules may also include monitoring the consumables inventory of a sample processing module. When a particular sample processing module is low or empty on a particular consumable (for example, pipette tips), a plate containing that consumable can be routed to the sample processing module. If a defined workflow process for a sample or sample plate includes the use of a particular sample processing module, the plate is routed to an available sample processing module. For example, if a sample plate is to be processed by DNA extraction sample processing module, and the modular robotic system includes two redundant DNA extraction sample processing module, and the first DNA extraction sample processing module is unavailable (such as due to its being in use, a malfunction, or unavailability of one or more consumables), the plate is routed to the second DNA extraction sample processing module even if not the most proximal DNA extraction sample processing module.

In some embodiments, there is provided a method of processing a biological sample in a modular robotic system, comprising sending movement information to a first robotic arm to receive a sample plate; and dynamically routing the sample plate to a selected sample processing module based on stateful data and a defined workflow process, the sample processing module selected from a plurality of sample processing modules (which may be redundant) based on a real-time load of each of the sample processing modules, wherein a first portion of the plurality of sample processing modules is accessible by the first robotic arm and inaccessible by a second robotic arm, and wherein a second portion of the plurality of sample processing modules is accessible by the second robotic arm and inaccessible by the first robotic arm. In some embodiments, the second portion of the plurality of sample processing modules comprises the selected sample processing module, and dynamically routing the plate comprises transporting the sample from a first node accessible by the first robotic arm and inaccessible by the second robotic arm to a second node accessible by the second robotic arm and inaccessible by the first robotic arm. Once the plate is routed to the sample processing module, one or more samples contained by the plate can be processed.

The automation system can also provide additional functions for monitoring and/or controlling the modular robotic system. For example, the automation system can monitor and/or control pressure sensors, regulators, valves, spill sensors, and volumes in waste containers. If an undesirable condition is detected, such as a triggered spill sensor, the automation system can suspend operation of a sample processing module or a robotic arm. The automation system can further control the liquid waste management system to operate pumps and/or control valves to allow emptying of liquid waste held in a liquid waste container based on a real-time monitoring of the liquid waste container emptying of other liquid waste containers in the modular robotic system, as further described herein. In some embodiments a method described herein includes monitoring a liquid waste volume in a plurality of liquid waste containers; and disposing of liquid waste contained with the plurality of liquid waste containers according to a liquid waste prioritization schedule.

The modular robotic system can further receive one or more consumable plates, and route the one or more consumable plates to a sample processing module. The consumable plates can contain, for example, items consumed by the sample processing modules during sample processing or priming of equipment on the sample processing module. For example, the consumable plate can include sample tubes, pipette tips, or one or more buffers. The consumable plates can be inputted into the modular robotic system, for example via the input/output module. The automation system can receive consumable inventory information from one or more sample processing modules, which indicates the inventory level of one or more consumables at the sample processing module. Once the inventory level is at or below a predetermined threshold for a particular consumable at a given sample processing module, the automated system can route a consumable plate containing that consumable to the sample processing module with the low inventory. For example, the automation system can send movement information to a robotic arm, which receives the consumable plate, and routes the consumable plate to the designated sample processing module. For example, the robotic arm can directly deliver the consumable plate to the sample processing plate when the robotic arm is contained within the same cell as the sample processing module. If the sample processing module is in a different cell, the robotic arm can route the consumable plate to a node on a bidirectional plate transportation track, and the consumable plate be routed to the appropriate cell along the bidirectional plate transportation track (for example by the automation system sending movement information to the bidirectional plate transportation track). Once the consumable plate is transported to the appropriate cell (that is, the cell with the sample processing module with low inventory for that consumable), the robotic arm within that cell can route the consumable plate from the node within the cell to the sample processing module, thus delivering the consumable to the sample processing module. The robotic arm can also retrieve the spent consumable plate from the sample processing module, and the spent consumable plate can be routed to the output nest to be removed from the modular robotic system. In some embodiments, the method further comprises monitoring a liquid waste volume in a plurality of liquid waste containers; and disposing of liquid waste contained with the plurality of liquid waste containers according to a liquid waste prioritization schedule.

The modular robotic system can receive or output plates (such as sample plates or spent consumable plates) through the input/output module. The input/output module can receive a single plate or a plurality of plate (e.g., a stack of plates). In some embodiments, the input/output module determines the number of plates in a stack of plates based on the weight or the height of stack. In some embodiments, the input/output module includes a plate identifier (e.g., barcode) reader, which can read a plate identifier on the one or more plates, and transmit the plate identifier to the automation system. The automation system can access a database to determine the type of plates and/or the samples or type of consumable contained within the plate. Based on the contents of the plate and any defined workflow process associated with the sample on the plate, the automation system can route the plate to a sample processing module or a holding nest by sending movement information to one or more robotic arms or a bidirectional plate transportation track. In some embodiments, the method further comprises monitoring a liquid waste volume in a plurality of liquid waste containers; and disposing of liquid waste contained with the plurality of liquid waste containers according to a liquid waste prioritization schedule.

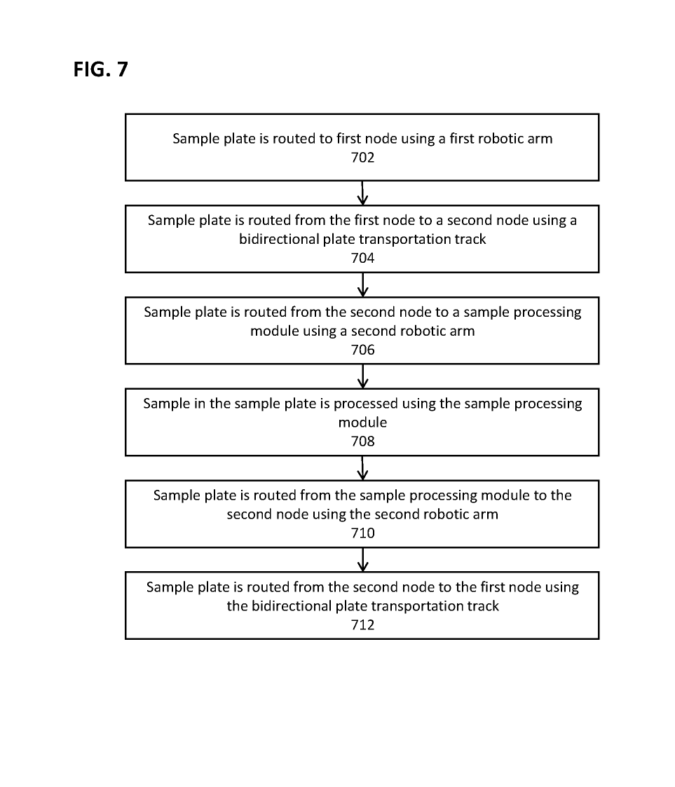

FIG. 7 illustrates an exemplary method of processing a biological sample using a modular robotic system. At step 702, a sample plate is routed to a first node of a bidirectional plate transportation track using a first robotic arm. At step 704, the plate is routed from the first node to a second node of the bidirectional plate transportation track. The second node is inaccessible by the first robotic arm. The second node is in a different cell as the first node, which may or may not be adjacent. At step 706, the plate is routed from the second node to a sample processing module using a second robotic arm. The second robotic arm cannot access the first node. At step 708, a sample in the plate is processed using the sample processing module. At step 710, the second robotic arm routes the plate from the sample processing module to the second node. At step 712, the plate is routed from the second node to the first node.

In some embodiments, a modular robotic system processes a biological sample by routing a plate (such as a sample plate or a consumable plate) to a first node using a first robotic arm; routing the plate from the first node to a second node (using, for example, the bidirectional plate transportation track), the second node inaccessible by the first robotic arm; routing the plate from the second node to a sample processing module using a second robotic arm; routing the plate from the sample processing module to the second node using the second robotic arm; and routing the plate from the second node to the first node (using, for example, the bidirectional plate transportation track). In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by routing a sample plate comprising the biological sample to a first node using a first robotic arm; routing the sample plate from the first node to a second node (using, for example, the bidirectional plate transportation track), the second node inaccessible by the first robotic arm; routing the sample plate from the second node to a sample processing module using a second robotic arm; processing the biological sample using the sample processing module; routing the sample plate from the sample processing module to the second node using the second robotic arm; and routing the sample plate from the second node to the first node (using, for example, the bidirectional plate transportation track). In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by routing a sample plate comprising the biological sample to a first node using a first robotic arm; routing the sample plate from the first node to a second node (using, for example, the bidirectional plate transportation track), the second node inaccessible by the first robotic arm; routing the sample plate from the second node to a first sample processing module using a second robotic arm; processing the biological sample using the first sample processing module; routing the sample plate from the sample processing module to the second node using the second robotic arm; and routing the sample plate from the second node to the first node (using, for example, the bidirectional plate transportation track); routing the sample plate from the first node to a second sample processing module using the first robotic arm; and processing the sample using the second sample processing module. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by receiving a sample plate comprising the biological sample from an input/output module using a first robotic arm; routing the sample plate to a first node using the first robotic arm; routing the sample plate from the first node to a second node (using, for example, the bidirectional plate transportation track), the second node inaccessible by the first robotic arm; routing the sample plate from the second node to a first sample processing module using a second robotic arm; processing the biological sample using the first sample processing module; routing the sample plate from the sample processing module to the second node using the second robotic arm; and routing the sample plate from the second node to the first node (using, for example, the bidirectional plate transportation track); routing the sample plate from the first node to a second sample processing module using the first robotic arm; and processing the sample using the second sample processing module. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by receiving a plate input request; receiving a sample plate comprising the biological sample from an input/output module using a first robotic arm; routing the sample plate to a first node using the first robotic arm; routing the sample plate from the first node to a second node (using, for example, the bidirectional plate transportation track), the second node inaccessible by the first robotic arm; routing the sample plate from the second node to a first sample processing module using a second robotic arm; processing the biological sample using the first sample processing module; routing the sample plate from the sample processing module to the second node using the second robotic arm; and routing the sample plate from the second node to the first node (using, for example, the bidirectional plate transportation track); routing the sample plate from the first node to a second sample processing module using the first robotic arm; and processing the sample using the second sample processing module. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by receiving a plate input request; receiving a sample plate comprising the biological sample from an input/output module using a first robotic arm; routing the sample plate to a first node using the first robotic arm; routing the sample plate from the first node to a second node (using, for example, the bidirectional plate transportation track), the second node inaccessible by the first robotic arm; routing the sample plate from the second node to a first sample processing module using a second robotic arm; processing the biological sample using the first sample processing module; routing the sample plate from the sample processing module to the second node using the second robotic arm; and routing the sample plate from the second node to the first node (using, for example, the bidirectional plate transportation track); routing the sample plate from the first node to a second sample processing module using the first robotic arm; processing the sample using the second sample processing module; routing the sample plate to an input/output module. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by receiving a plate input request; receiving a sample plate comprising the biological sample from an input/output module using a first robotic arm; routing the sample plate to a first node using the first robotic arm; routing the sample plate from the first node to a second node (using, for example, the bidirectional plate transportation track), the second node inaccessible by the first robotic arm; routing the sample plate from the second node to a first sample processing module using a second robotic arm; processing the biological sample using the first sample processing module; routing the sample plate from the sample processing module to the second node using the second robotic arm; routing the sample plate from the second node to the first node (using, for example, the bidirectional plate transportation track); routing the sample plate from the first node to a second sample processing module using the first robotic arm; processing the sample using the second sample processing module; receiving a sample plate output request; routing the sample plate to an input/output module. In some embodiments, the method further comprises monitoring a liquid waste volume in a plurality of liquid waste containers; and disposing of liquid waste contained with the plurality of liquid waste containers according to a liquid waste prioritization schedule.

The modular robotic system can include a plurality of cells and/or robotic arms. During processing of a sample, it may be desirable to route a plate from a first cell to a nonadjacent cell. Using the bidirectional plate transportation track, plates can be transported from a first cell to a second cell, wherein the first cell and the second cell are not adjacent (i.e., a third cell is disposed between the first cell and the second cell). The bidirectional plate transportation track allows the plate to bypass the intermediate cell, which allows the robotic arm disposed within the intermediate cell to continue routing plates without needing to route the plate bypassing the intermediate cell. In some embodiments, a modular robotic system processes a biological sample by routing a plate (such as a sample plate or a consumable plate) to a first node using a first robotic arm; routing the plate from the first node to a second node (using, for example, the bidirectional plate transportation track), the second node being inaccessible by the first robotic arm; and routing the plate from the second node to a sample processing module using a second robotic arm; wherein a third robotic arm is disposed between the first robotic arm and the second robotic arm, and the third robotic arm is bypassed when the plate is transported from the first node to the second node. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by routing a plate (such as a sample plate or a consumable plate) to a first node using a first robotic arm; routing the plate from the first node to a second node (using, for example, the bidirectional plate transportation track), the second node being inaccessible by the first robotic arm; and routing the plate from the second node to a sample processing module using a second robotic arm; routing the plate from the sample processing module to the second node using the second robotic arm; and routing the plate from the second node to the first node (using, for example, the bidirectional plate transportation track); wherein a third robotic arm is disposed between the first robotic arm and the second robotic arm, and the third robotic arm is bypassed when the plate is transported from the first node to the second node and/or from the second node to the first node. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by routing a sample plate comprising a sample to a first node using a first robotic arm; routing the sample plate from the first node to a second node (using, for example, the bidirectional plate transportation track), the second node being inaccessible by the first robotic arm; routing the sample plate from the second node to a sample processing module using a second robotic arm; processing the sample using the sample processing module; routing the sample plate from the sample processing module to the second node using the second robotic arm; and routing the sample plate from the second node to the first node (using, for example, the bidirectional plate transportation track); wherein a third robotic arm is disposed between the first robotic arm and the second robotic arm, and the third robotic arm is bypassed when the plate is transported from the first node to the second node and/or from the second node to the first node. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by routing a sample plate comprising a sample to a first node using a first robotic arm; routing the sample plate from the first node to a second node (using, for example, the bidirectional plate transportation track), the second node being inaccessible by the first robotic arm; routing the sample plate from the second node to a first sample processing module using a second robotic arm; processing the sample using the first sample processing module; routing the sample plate from the sample processing module to the second node using the second robotic arm; routing the sample plate from the second node to the first node (using, for example, the bidirectional plate transportation track); routing the sample plate from the first node to a second sample processing module using the first robotic arm; and processing the sample using the second sample processing module; wherein a third robotic arm is disposed between the first robotic arm and the second robotic arm, and the third robotic arm is bypassed when the plate is transported from the first node to the second node and/or from the second node to the first node. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by receiving a sample plate comprising the biological sample from an input/output module using a first robotic arm; routing the sample plate to a first node using the first robotic arm; routing a sample plate comprising a sample to a first node using a first robotic arm; routing the sample plate from the first node to a second node (using, for example, the bidirectional plate transportation track), the second node being inaccessible by the first robotic arm; routing the sample plate from the second node to a first sample processing module using a second robotic arm; processing the sample using the first sample processing module; routing the sample plate from the sample processing module to the second node using the second robotic arm; routing the sample plate from the second node to the first node (using, for example, the bidirectional plate transportation track); routing the sample plate from the first node to a second sample processing module using the first robotic arm; and processing the sample using the second sample processing module; wherein a third robotic arm is disposed between the first robotic arm and the second robotic arm, and the third robotic arm is bypassed when the plate is transported from the first node to the second node and/or from the second node to the first node. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by receiving a sample plate comprising the biological sample from an input/output module using a first robotic arm; routing the sample plate to a first node using the first robotic arm; routing a sample plate comprising a sample to a first node using a first robotic arm; routing the sample plate from the first node to a second node (using, for example, the bidirectional plate transportation track), the second node being inaccessible by the first robotic arm; routing the sample plate from the second node to a first sample processing module using a second robotic arm; processing the sample using the first sample processing module; routing the sample plate from the sample processing module to the second node using the second robotic arm; routing the sample plate from the second node to the first node (using, for example, the bidirectional plate transportation track); routing the sample plate from the first node to a second sample processing module using the first robotic arm; processing the sample using the second sample processing module; receiving a sample plate output request; and routing the sample plate to the input/output module; wherein a third robotic arm is disposed between the first robotic arm and the second robotic arm, and the third robotic arm is bypassed when the plate is transported from the first node to the second node and/or from the second node to the first node. In some embodiments, the method further comprises monitoring a liquid waste volume in a plurality of liquid waste containers; and disposing of liquid waste contained with the plurality of liquid waste containers according to a liquid waste prioritization schedule.

In some embodiments, the sample processing module simultaneously processes or routes a plurality of plates (which may be sample plates, consumable plates, or a combination thereof). In some embodiments, the sample processing module simultaneously processes and/or routes two or more, three or more, four or more, five or more, six or more, seven or more, eight or more, nine or more, ten or more, fifteen or more, or 20 or more plates. In some embodiments, a modular robotic system processes a first biological sample in a first plate and a second biological sample in a second plate by: (a) routing the first sample plate to a first node using a first robotic arm; routing the first sample plate form the first node to a second node (using, for example, the bidirectional plate transportation track), the second node inaccessible by the first robotic arm; routing the first sample plate from the second node to a first sample processing module using a second robotic arm; processing the first sample using the first sample processing module; routing the first sample plate from the sample processing module to the second node using the second robotic arm; and routing the first sample plate from the second node to the first node; and (b) routing the second sample plate to the second node using the second robotic arm; routing the second sample plate form the second node to the first node (using, for example, the bidirectional plate transportation track), the first node inaccessible by the first second robotic arm; routing the second sample plate from the first node to a second sample processing module using the first robotic arm; processing the second sample using the second sample processing module; routing the second sample plate from the second sample processing module to the first node using the first robotic arm; and routing the second sample plate from the first node to the second node. In some embodiments, the first sample and the second sample are processed simultaneously. In some embodiments, the method further comprises monitoring a liquid waste volume in a plurality of liquid waste containers; and disposing of liquid waste contained with the plurality of liquid waste containers according to a liquid waste prioritization schedule.

The modular robotic system can dynamically route sample plates to a sample processing module based on the real-time loads of the sample processing modules in the modular robotic system. For example, the modular robotic system can include two or more, three or more, four or more, or five more redundant sample processing modules. The samples can have a defined workflow process, wherein each processing step is predetermined, but the sample need not be restricted to being processed in a predetermined sample processing module. In some embodiments, a modular robotic system processes a biological sample by dynamically routing a sample plate to a selected sample processing module based on stateful data and a defined workflow process, the sample processing module selected from a plurality of sample processing modules (which may be redundant) based on a real-time load of each of the sample processing modules, wherein a first portion of the plurality of sample processing modules is accessible by a first robotic arm and inaccessible by a second robotic arm, and wherein a second portion of the plurality of sample processing modules is accessible by the second robotic arm and inaccessible by the first robotic arm. In some embodiments, the method further comprises monitoring a liquid waste volume in a plurality of liquid waste containers; and disposing of liquid waste contained with the plurality of liquid waste containers according to a liquid waste prioritization schedule.

In some embodiments, a modular robotic system processes a biological sample by dynamically routing a sample plate to a selected sample processing module based on stateful data and a defined workflow process, the sample processing module selected from a plurality of sample processing modules (which may be redundant) based on a real-time load of each of the sample processing modules, wherein a first portion of the plurality of sample processing modules is accessible by a first robotic arm and inaccessible by a second robotic arm, and wherein a second portion of the plurality of sample processing modules is accessible by the second robotic arm and inaccessible by the first robotic arm; wherein the second portion of the plurality of sample processing modules comprises the selected sample processing module, and dynamically routing the plate comprises transporting the sample from a first node accessible by the first robotic arm and inaccessible by the second robotic arm to a second node accessible by the second robotic arm and inaccessible by the first robotic arm. In some embodiments, the method further comprises monitoring a liquid waste volume in a plurality of liquid waste containers; and disposing of liquid waste contained with the plurality of liquid waste containers according to a liquid waste prioritization schedule.

### Computer Systems for Operating the Modular Robotic System

The modular robotic system can include a computer system that is operable to perform methods described herein. The computer system can be connected to various robotic system components, such as valves, pumps, sensors, robotic arms, bidirectional tracks, and/or processing modules using the data network. The computer system may operate the various components dynamically based on load balancing, through a prioritization schedule, or through a user request, as described herein.

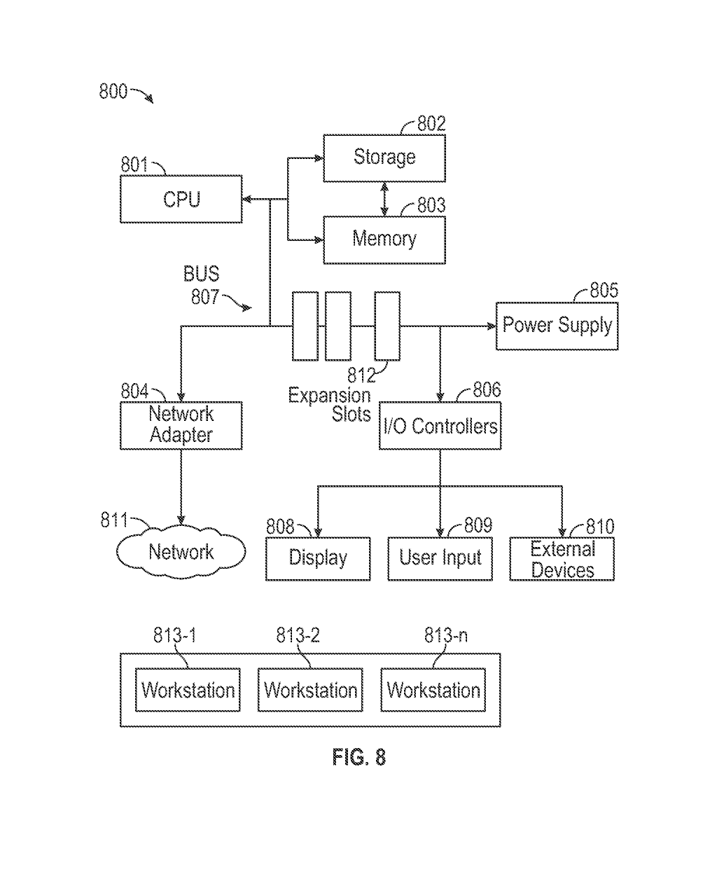

FIG. 8 illustrates an exemplary computing system or electronic device for implementing the examples of the disclosure. System 800 may include, but is not limited to known components such as central processing unit (CPU) 801, storage 802, memory 803, network adapter 804, power supply 805, input/output (I/O) controllers 806, electrical bus 807, one or more displays 808, one or more user input devices 809, and other external devices 810. It will be understood by those skilled in the art that system 800 may contain other well-known components which may be added, for example, via expansion slots 812, or by any other method known to those skilled in the art. Such components may include, but are not limited, to hardware redundancy components (e.g., dual power supplies or data backup units), cooling components (e.g., fans or water-based cooling systems), additional memory and processing hardware, and the like.

System 800 may be, for example, in the form of a client-server computer capable of connecting to and/or facilitating the operation of a plurality of workstations or similar computer systems over a network. In another embodiment, system 800 may connect to one or more workstations over an intranet or internet network, and thus facilitate communication with a larger number of workstations or similar computer systems. Even further, system 800 may include, for example, a main workstation or main general purpose computer to permit a user to interact directly with a central server. Alternatively, the user may interact with system 800 via one or more remote or local workstations 813. As will be appreciated by one of ordinary skill in the art, there may be any practical number of remote workstations for communicating with system 800.

CPU 801 may include one or more processors, for example Intel® Core™ i7 processors, AMD FX™ Series processors, or other processors as will be understood by those skilled in the art (e.g., including graphical processing unit (GPU)-style specialized computing hardware used for, among other things, machine learning applications, such as training and/or running the machine learning algorithms of the disclosure). CPU 801 may further communicate with an operating system, such as Windows 10® operating system by Microsoft Corporation, Linux operating system, or a Unix-like operating system. However, one of ordinary skill in the art will appreciate that similar operating systems may also be utilized. Storage 802 (e.g., non-transitory computer readable medium) may include one or more types of storage, as is known to one of ordinary skill in the art, such as a hard disk drive (HDD), solid state drive (SSD), hybrid drives, and the like. In one example, storage 802 is utilized to persistently retain data for long-term storage. Memory 803 (e.g., non-transitory computer readable medium) may include one or more types of memory as is known to one of ordinary skill in the art, such as random access memory (RAM), read-only memory (ROM), hard disk or tape, optical memory, or removable hard disk drive. Memory 803 may be utilized for short-term memory access, such as, for example, loading software applications or handling temporary system processes.

As will be appreciated by one of ordinary skill in the art, storage 802 and/or memory 803 may store one or more computer software programs. Such computer software programs may include logic, code, and/or other instructions to enable processor 801 to perform the tasks, operations, and other functions as described herein, and additional tasks and functions as would be appreciated by one of ordinary skill in the art. Operating system 802 may further function in cooperation with firmware, as is well known in the art, to enable processor 801 to coordinate and execute various functions and computer software programs as described herein. Such firmware may reside within storage 802 and/or memory 603.

Moreover, I/O controllers 806 may include one or more devices for receiving, transmitting, processing, and/or interpreting information from an external source, as is known by one of ordinary skill in the art. In one embodiment, I/O controllers 806 may include functionality to facilitate connection to one or more user devices 809, such as one or more keyboards, mice, microphones, trackpads, touchpads, or the like. For example, I/O controllers 806 may include a serial bus controller, universal serial bus (USB) controller, FireWire controller, and the like, for connection to any appropriate user device. I/O controllers 806 may also permit communication with one or more wireless devices via technology such as, for example, near-field communication (NFC) or Bluetooth™. In one embodiment, I/O controllers 806 may include circuitry or other functionality for connection to other external devices 810 such as modem cards, network interface cards, sound cards, printing devices, external display devices, or the like. Furthermore, I/O controllers 806 may include controllers for a variety of display devices 808 known to those of ordinary skill in the art. Such display devices may convey information visually to a user or users in the form of pixels, and such pixels may be logically arranged on a display device in order to permit a user to perceive information rendered on the display device. Such display devices may be in the form of a touch-screen device, traditional non-touch screen display device, or any other form of display device as will be appreciated be one of ordinary skill in the art.

Furthermore, CPU 801 may further communicate with I/O controllers 806 for rendering a graphical user interface (GUI) on, for example, one or more display devices 808. In one example, CPU 801 may access storage 802 and/or memory 803 to execute one or more software programs and/or components to allow a user to interact with the system as described herein. In one embodiment, a GUI as described herein includes one or more icons or other graphical elements with which a user may interact and perform various functions. For example, GUI 807 may be displayed on a touch screen display device 608, whereby the user interacts with the GUI via the touch screen by physically contacting the screen with, for example, the user's fingers. As another example, GUI may be displayed on a traditional non-touch display, whereby the user interacts with the GUI via keyboard, mouse, and other conventional I/O components 809. GUI may reside in storage 802 and/or memory 803, at least in part as a set of software instructions, as will be appreciated by one of ordinary skill in the art. Moreover, the GUI is not limited to the methods of interaction as described above, as one of ordinary skill in the art may appreciate any variety of means for interacting with a GUI, such as voice-based or other disability-based methods of interaction with a computing system.

Moreover, network adapter 804 may permit device 800 to communicate with network 811. Network adapter 804 may be a network interface controller, such as a network adapter, network interface card, LAN adapter, or the like. As will be appreciated by one of ordinary skill in the art, network adapter 804 may permit communication with one or more networks 811, such as, for example, a local area network (LAN), metropolitan area network (MAN), wide area network (WAN), cloud network (IAN), or the Internet.

One or more workstations 813 may include, for example, known components such as a CPU, storage, memory, network adapter, power supply, I/O controllers, electrical bus, one or more displays, one or more user input devices, and other external devices. Such components may be the same, similar, or comparable to those described with respect to system 800 above. It will be understood by those skilled in the art that one or more workstations 813 may contain other well-known components, including but not limited to hardware redundancy components, cooling components, additional memory/processing hardware, and the like.

### EXEMPLARY EMBODIMENTS

The following embodiments are exemplary of the invention disclosed herein, and should not be considered limiting.

### Embodiment 1

A modular robotic system for processing biological samples comprising:

two or more sample processing modules;

a water supply system connected to the two or more sample processing modules, the water supply system comprising a main water supply conduit and one or more water supply manifolds;

a liquid waste disposal system connected to the two or more sample processing modules, the liquid waste disposal system comprising a main liquid waste disposal conduit and one or more liquid waste disposal manifolds connected to at least one sample processing module;

one or more power supply systems connected to a main power supply line and at least one of the sample processing modules;

a bidirectional plate transportation track configured to transport a plate between at least a first node and a second node; and

a first robotic arm configured to transport the plate between the first node and a first sample processing module, and a second robotic arm configured to transport the plate between the second node and a second sample processing module.

### Embodiment 2

The modular robotic system of embodiment 2, wherein the second sample processing module and the second node are unreachable by the first robotic arm, and the first sample processing module and the first node are unreachable by the second robotic arm.

### Embodiment 3

The modular robotic system of embodiment 1 or 2, further comprising a third robotic arm disposed between the first robotic arm and the second robotic arm, wherein the bidirectional plate transportation track is configured to transport the plate from the first node and the second node without the plate contacting the third robotic arm.

### Embodiment 4

The modular robotic system of any one of embodiments 1-3, wherein the water supply system comprises an extendable terminus.

### Embodiment 5

The modular robotic system of any one of embodiments 1-4, wherein the water supply system comprises a valve disposed between a water supply manifold and a sample processing module.

### Embodiment 6

The modular robotic system of any one of embodiments 1-5, wherein the water supply system comprises a pressure regulator disposed between a water supply manifold and a sample processing module.

### Embodiment 7

The modular robotic system of any one of embodiments 1-6, wherein the water supply system comprises a flow sensor disposed along the main water supply conduit.

### Embodiment 8

The modular robotic system of any one of embodiments 1-7, wherein the water supply system comprises a pressure regulator disposed along the main water supply conduit.

### Embodiment 9

The modular robotic system of any one of embodiments 1-8, wherein the water supply system terminus is disposed at an end of the main water supply conduit.

### Embodiment 10

The modular robotic system of any one of embodiments 1-9, wherein the water supply system terminus is a valve.

### Embodiment 11

The modular robotic system of any one of embodiments 1-10, wherein the main water supply conduit is configured to be extendable from the water supply system terminus.

### Embodiment 12

The modular robotic system of any one of embodiments 1-11, wherein the power supply system comprises a transformer configured to receive power from the main power supply line and supply single phase 240 VAC power to one or more sample processing modules.

### Embodiment 13

The modular robotic system of any one of embodiments 1-12, wherein the power supply system is configured to receive power from the main power supply line and supply three-phase 208 VAC, single-phase 120 VAC, or 24 VDC power to one or more sample processing modules.

### Embodiment 14

The modular robotic system of any one embodiments 1-13, wherein the power supply system comprises a battery.

### Embodiment 15

The modular robotic system of any one of embodiments 1-14, further comprising a data network configured to provide communication between the two or more sample processing modules and a computer system.

### Embodiment 16

The modular robotic system of embodiment 15, wherein the data network comprises one or more switches, wherein the one or more switches are connected to the two or more sample processing modules and the computer system.

### Embodiment 17

The modular robotic system of any one of embodiments 1-16, wherein the liquid waste disposal system comprises an expandable liquid waste disposal system terminus.

### Embodiment 18

The modular robotic system of any one of embodiments 1-17, wherein the liquid waste disposal system comprises a valve or regulator disposed between one of the one or more liquid waste disposal manifolds and one of the two or more sample processing modules.

### Embodiment 19

The modular robotic system of embodiment 18, wherein the valve or regulator disposed between the liquid waste disposal manifold and the sample processing module is operable to selectively open only when flow of liquid waste from any other sample processing module to the liquid waste disposal system is prevented.

### Embodiment 20

The modular robotic system of embodiment 19, wherein the valve or regulator is operable to selectively open according to a liquid waste disposal prioritization schedule.

### Embodiment 21

The modular robotic system of any one of embodiments 1-20, wherein the liquid waste disposal system comprises a pump disposed between the liquid waste disposal manifold and one of the two or more sample processing modules.

### Embodiment 22

The modular robotic system of embodiment 21, wherein the pump disposed between the liquid waste disposal manifold and the sample processing module is operable to selectively pump liquid waste into the liquid waste disposal system only when flow of liquid waste from any other sample processing module to the liquid waste disposal system is prevented.

### Embodiment 23

The modular robotic system of embodiment 22, wherein the pump is operable to selectively pump liquid waste into the liquid waste disposal system according to a liquid waste prioritization schedule.

### Embodiment 24

The modular robotic system of any one of embodiments 1-23, wherein the liquid waste disposal system comprises a flow sensor or a pressure regulator disposed along the main liquid waste disposal conduit.

### Embodiment 25

The modular robotic system of any one of embodiments 1-24, wherein the liquid waste disposal system comprises a pump disposed along the main liquid waste disposal conduit.

### Embodiment 26

The modular robotic system of any one of embodiments 1-25, wherein the liquid waste disposal system terminus is disposed at an end of the main liquid waste disposal conduit.

### Embodiment 27

The modular robotic system of any one of embodiments 1-26, wherein the liquid waste disposal system terminus is a valve.

### Embodiment 28

The modular robotic system of any one of embodiments 1-27, wherein the main liquid waste disposal conduit is configured to be extendable from the water supply system terminus.

### Embodiment 29

The modular robotic system of any one of embodiments 1-28, further comprising a vacuum system connected to the two or more sample processing modules, the vacuum system comprising a main vacuum conduit and one or more vacuum manifolds.

### Embodiment 30

The modular robotic system of embodiment 29, wherein the vacuum system further comprises an extendable terminus.

### Embodiment 31

The modular robotic system of embodiment 29 or 30, wherein the vacuum system further comprises a valve disposed between one of the one or more vacuum manifolds and one of the two or more sample processing modules.

### Embodiment 32

The modular robotic system of embodiment 31, wherein the valve disposed between the vacuum manifold and the sample processing module is operable to selectively open only when vacuum to any other sample processing module from the vacuum system is prevented.

### Embodiment 33

The modular robotic system of embodiment 32, wherein the valve is operable to selectively open according to a vacuum system prioritization schedule.

### Embodiment 34

The modular robotic system of any one of embodiments 30-33, wherein the vacuum system terminus is disposed at an end of the main vacuum conduit.

### Embodiment 35

The modular robotic system of any one of embodiments 30-34, wherein the vacuum system terminus is a valve.

### Embodiment 36

The modular robotic system of any one of embodiments 1-35, further comprising a compressed gas system connected to the two or more sample processing modules, the compressed gas system comprising a main compressed gas supply conduit and one or more compressed gas manifolds.

### Embodiment 37

The modular robotic system of embodiment 36, the compressed gas system further comprises an extendable compressed gas system terminus.

### Embodiment 38

The modular robotic system of embodiment 36 or 37, wherein the compressed gas system further comprises a valve disposed between one of the one or more compressed gas manifolds and one of the two or more sample processing modules.

### Embodiment 39

The modular robotic system of embodiment 38, wherein the valve disposed between the compressed gas manifold and the sample processing module is operable to selectively open only when compressed gas to any other sample processing module from the compressed gas system is prevented.

### Embodiment 40

The modular robotic system of embodiment 39, wherein the valve is operable to selectively open according to a compressed gas system prioritization schedule.

### Embodiment 41

The modular robotic system of any one of embodiments 37-40, wherein the compressed gas system terminus is disposed at an end of the main compressed gas supply conduit.

### Embodiment 42

The modular robotic system of any one of embodiments 37-41, wherein the compressed gas system terminus is a valve.

### Embodiment 43

The modular robotic system of any one of embodiments 1-42, further comprising a light curtain disposed along the perimeter of the modular robot, wherein penetration of the light curtain suspends operation of at least one of the robotic arms.

### Embodiment 44

The modular robotic system of embodiment 43, wherein penetration of the light curtain suspends operation of one robotic arm without suspending operation of the other robotic arms in the modular robotic system.

### Embodiment 45

The modular robotic system of any one of embodiments 1-44, further comprising a plate input/output module comprising:

a plate identifier configured to identify a plate or a type of plate;

a plate nest, wherein at least one of the robotic arms is configured to retrieve a plate from the plate nest or transport a plate to the plate nest; and

an input signaler configured to submit a request to a computer system, which operates the robotic arm to retrieve the plate from the plate nest.

### Embodiment 46

The modular robotic system of embodiment 45, wherein the plate nest is positioned between a first light curtain and a second light curtain, and the first light curtain is positioned between the plate nest and the robotic arm, wherein simultaneous penetration of the first light curtain and the second light curtain suspends operation of the robotic arm.

### Embodiment 47

The modular robotic system of embodiment 45 or 46, wherein, in response to the computer system receiving a user request for an identified sample or an identified plate, the robotic arm is operable to retrieve the identified sample or the identified plate and position the identified sample or the identified plate within the plate nest of the input/output module.

### Embodiment 48

The modular robotic system of any one of embodiments 1-47, wherein the modular robot comprises a plate loading module.

### Embodiment 49

The modular robotic system of embodiment 48, wherein the plate loading module is configured to determine how many plates of a particular plate type are in the plate loading module.

### Embodiment 50

The modular robotic system of embodiment 49, wherein the plate loading module determines how many plates of a particular plate type are in the plate loading module based on the height of a plate stack or a weight of a plate stack.

### Embodiment 51

The modular robotic system of any one of embodiments 1-50, further comprising a barcode applicator.

### Embodiment 52

The modular robotic system of any one of embodiments 1-51, wherein the plate is a sample plate or a consumable plate.

### Embodiment 53

A method of processing a biological sample in a modular robotic system, comprising:

routing a plate to a first node using a first robotic arm;

routing the plate from the first node to a second node, the second node inaccessible by the first robotic arm;

routing the plate from the second node to a sample processing module using a second robotic arm;

routing the plate from the sample processing module to the second node using the second robotic arm; and

routing the plate from the second node to the first node.

### Embodiment 54

A method of processing a biological sample in a modular robotic system, comprising:

routing a plate to a first node using a first robotic arm;

routing the plate from the first node to a second node, the second node being inaccessible by the first robotic arm; and

routing the plate from the second node to a sample processing module using a second robotic arm;

wherein a third robotic arm is disposed between the first robotic arm and the second robotic arm, and the third robotic arm is bypassed when the plate is transported from the first node to the second node.

### Embodiment 55

The method of embodiment 54, further comprising

routing the plate from the sample processing module to the second node using the second robotic arm; and

routing the plate from the second node to the first node.

### Embodiment 56

The method of any one of embodiments 53-55, wherein the plate is a sample plate.

### Embodiment 57

The method of embodiment 56, further comprising processing a sample in the sample plate at the sample processing module.

### Embodiment 58

The method of embodiment 56 or 57 further comprising routing the plate from the first node to a second processing module using the first robotic arm.

### Embodiment 59

The method of embodiment 58, further comprising processing a sample in the sample plate at the second sample processing module.

### Embodiment 60

The method of any one of embodiments 53-55, wherein the plate is a consumable plate.

### Embodiment 61

A method of processing a biological sample in a modular robotic system, comprising:

dynamically routing a sample plate to a selected sample processing module based on stateful data and a defined workflow process, the sample processing module selected from a plurality of sample processing modules based on a real-time load of each of the sample processing modules, wherein a first portion of the plurality of sample processing modules is accessible by a first robotic arm and inaccessible by a second robotic arm, and wherein a second portion of the plurality of sample processing modules is accessible by the second robotic arm and inaccessible by the first robotic arm.

### Embodiment 62

The method of embodiment 61, wherein the plurality of sample processing modules are redundant.

### Embodiment 63

The method of embodiment 61 or 62, wherein the second portion of the plurality of sample processing modules comprises the selected sample processing module, and dynamically routing the plate comprises transporting the sample from a first node accessible by the first robotic arm and inaccessible by the second robotic arm to a second node accessible by the second robotic arm and inaccessible by the first robotic arm.

### Embodiment 64

The method of any one of embodiments 61-63, further comprising processing a sample in the sample plate at the selected sample processing module.

### Embodiment 65

The method of any one of embodiments 53-64, comprising receiving a plate input request.

### Embodiment 66

The method of any one of embodiments 53-65, further comprising receiving the plate from an input/output module using the first robotic arm.

### Embodiment 67

The method of any one of embodiments 53-66, comprising receiving a plate output request.

### Embodiment 68

The method of any one of embodiments 53-67, further comprising routing the plate to an input/output module using the first robotic arm.

### Embodiment 69

The method of any one of embodiments 53-68, further comprising:

monitoring a liquid waste volume in a plurality of liquid waste containers; and

disposing of liquid waste contained with the plurality of liquid waste containers according to a liquid waste prioritization schedule.

### Embodiment 70

The method of any one of embodiments 53-69, wherein the plate is routed using a bidirectional plate transportation track.

### Embodiment 71

A modular robotic system for processing biological samples comprising:

two or more sample processing modules comprising a first sample processing module and a second sample processing module;

a water supply system connected to the two or more sample processing modules, the water supply system comprising a main water supply conduit and one or more water supply manifolds;

a liquid waste disposal system connected to the two or more sample processing modules, the liquid waste disposal system comprising a main liquid waste disposal conduit and one or more liquid waste disposal manifolds connected to at least one sample processing module;

one or more power supply systems connected to a main power supply line and at least one of the two or more sample processing modules;

a bidirectional plate transportation track configured to transport a plate between at least a first node and a second node; and

a plurality of robotic arms comprising a first robotic arm configured to transport the plate between the first node and the first sample processing module, and a second robotic arm configured to transport the plate between the second node and the second sample processing module.

### Embodiment 72

The modular robotic system of embodiment 71, wherein the second sample processing module and the second node are unreachable by the first robotic arm, and the first sample processing module and the first node are unreachable by the second robotic arm.

### Embodiment 73

The modular robotic system of embodiment 71 or 72, wherein the plurality of robotic arms further comprises a third robotic arm disposed between the first robotic arm and the second robotic arm, wherein the bidirectional plate transportation track is configured to transport the plate between the first node and the second node without the plate contacting the third robotic arm.

### Embodiment 74

The modular robotic system of any one of embodiments 71-73, wherein the water supply system comprises a valve disposed between one of the water supply manifolds and one of the two or more sample processing modules.

### Embodiment 75

The modular robotic system of any one of embodiments 71-74, wherein the water supply system comprises a pressure regulator disposed between one of the water supply manifolds and one of the two or more sample processing modules.

### Embodiment 76

The modular robotic system of any one of embodiments 71-75, wherein the water supply system comprises a flow sensor disposed along the main water supply conduit.

### Embodiment 77

The modular robotic system of any one of embodiments 71-76, wherein the water supply system comprises a pressure regulator disposed along the main water supply conduit.

### Embodiment 78

The modular robotic system of any one of embodiments 71-77, wherein the water supply system comprises an extendable water supply system terminus.

### Embodiment 79

The modular robotic system of embodiment 78, wherein the extendable water supply system terminus is positioned on the main water supply conduit.

### Embodiment 80

The modular robotic system of embodiment 79, wherein the extendable water supply system terminus is positioned at an end of the main water supply conduit.

### Embodiment 81

The modular robotic system of any one of embodiments 78-80, wherein the extendable main water supply system terminus comprises a valve.

### Embodiment 82

The modular robotic system of any one of embodiments 71-81, wherein the one or more power supply systems are configured to receive power from the main power supply line and supply three-phase alternating current, single-phase alternating current, or direct current to one or more of the two or more sample processing modules.

### Embodiment 83

The modular robotic system of any one of embodiments 71-82, wherein the power supply system comprises a transformer configured to receive power from the main power supply line and supply single-phase power to one or more of the two or more sample processing modules.

### Embodiment 84

The modular robotic system of any one of embodiments 71-83, wherein the power supply system comprises a battery.

### Embodiment 85

The modular robotic system of any one of embodiments 71-84, further comprising a data network configured to provide communication between the two or more sample processing modules and a computer system.

### Embodiment 86

The modular robotic system of embodiment 85, wherein the data network comprises one or more switches, wherein the one or more switches are connected to the two or more sample processing modules and the computer system.

### Embodiment 87

The modular robotic system of any one of embodiments 71-86, wherein the liquid waste disposal system comprises a valve or regulator disposed between one of the one or more liquid waste disposal manifolds and one of the two or more sample processing modules.

### Embodiment 88

The modular robotic system of embodiment 87, wherein the valve or regulator disposed between the one of the one or more liquid waste disposal manifolds and the one of the two or more sample processing module is operable to selectively open only when flow of liquid waste from any other sample processing module to the liquid waste disposal system is prevented.

### Embodiment 89

The modular robotic system of embodiment 88, wherein the valve or regulator is operable to selectively open according to a liquid waste disposal prioritization schedule.

### Embodiment 90

The modular robotic system of any one of embodiments 71-89, wherein the liquid waste disposal system comprises a pump disposed between one of the one or more liquid waste disposal manifolds and one of the two or more sample processing modules.

### Embodiment 91

The modular robotic system of embodiment 90, wherein the pump disposed between the one of the one or more liquid waste disposal manifolds and the one of the two or more sample processing modules is operable to selectively pump liquid waste into the liquid waste disposal system only when flow of liquid waste from any other sample processing module to the liquid waste disposal system is prevented.

### Embodiment 92

The modular robotic system of embodiment 91, wherein the pump is operable to selectively pump liquid waste into the liquid waste disposal system according to a liquid waste prioritization schedule.

### Embodiment 93

The modular robotic system of any one of embodiments 71-92, wherein the liquid waste disposal system comprises a flow sensor or a pressure regulator disposed along the main liquid waste disposal conduit.

### Embodiment 94

The modular robotic system of any one of embodiments 71-93, wherein the liquid waste disposal system comprises a pump disposed along the main liquid waste disposal conduit.

### Embodiment 95

The modular robotic system of any one of embodiments 71-94, wherein the liquid waste disposal system comprises an extendable liquid waste disposal system terminus.

### Embodiment 96

The modular robotic system of embodiment 95, wherein the extendable liquid waste disposal system terminus is disposed on the liquid waste disposal conduit.

### Embodiment 97

The modular robotic system of embodiment 96, wherein the extendable liquid waste disposal system terminus is disposed at an end of the main liquid waste disposal conduit.

### Embodiment 98

The modular robotic system of embodiment 96 or 97, wherein the extendable liquid waste disposal system terminus comprises a valve.

### Embodiment 99

The modular robotic system of any one of embodiments 71-98, further comprising a vacuum system connected to the two or more sample processing modules, the vacuum system comprising a main vacuum conduit and one or more vacuum manifolds.

### Embodiment 100

The modular robotic system of embodiment 99, wherein the vacuum system further comprises a valve disposed between one of the one or more vacuum manifolds and one of the two or more sample processing modules.

### Embodiment 101

The modular robotic system of embodiment 100, wherein the valve disposed between the one of the one or more vacuum manifolds and the one of the two or more sample processing modules is operable to selectively open only when vacuum to any other sample processing module from the vacuum system is prevented.

### Embodiment 102

The modular robotic system of embodiment 101, wherein the valve is operable to selectively open according to a vacuum system prioritization schedule.

### Embodiment 103

The modular robotic system of any one of embodiments 99-102, wherein the vacuum system comprises an extendable vacuum system terminus.

### Embodiment 104

The modular robotic system of any one of embodiments 99-103, wherein the extendable vacuum system terminus is disposed on the main vacuum conduit.

### Embodiment 105

The modular robotic system of embodiment 104, wherein the extendable vacuum system terminus is disposed at an end of the main vacuum conduit.

### Embodiment 106

The modular robotic system of any one of embodiments 103-105, wherein the extendable vacuum system terminus comprises a valve.

### Embodiment 107

The modular robotic system of any one of embodiments 71-106, further comprising a compressed gas system connected to the two or more sample processing modules, the compressed gas system comprising a main compressed gas supply conduit and one or more compressed gas manifolds.

### Embodiment 108

The modular robotic system of embodiment 107, wherein the compressed gas system further comprises a valve disposed between one of the one or more compressed gas manifolds and one of the two or more sample processing modules.

### Embodiment 109

The modular robotic system of embodiment 108, wherein the valve disposed between the one of the one or more compressed gas manifolds and the one of the two or more sample processing modules is operable to selectively open only when compressed gas to any other sample processing module from the compressed gas system is prevented.

### Embodiment 110

The modular robotic system of embodiment 109, wherein the valve is operable to selectively open according to a compressed gas system prioritization schedule.

### Embodiment 111

The modular robotic system of any one of embodiments 107-110, wherein the compressed gas system comprises an extendable compressed gas system terminus.

### Embodiment 112

The modular robotic system of embodiment 111, wherein the extendable compressed gas system terminus is disposed on the main compressed gas supply conduit.

### Embodiment 113

The modular robotic system of embodiment 111 or 112, wherein the extendable compressed gas system terminus is disposed at an end of the main compressed gas supply conduit.

### Embodiment 114

The modular robotic system of any one of embodiments 111-113, wherein the extendable compressed gas system terminus comprises a valve.

### Embodiment 115

The modular robotic system of any one of embodiments 71-114, further comprising a light curtain disposed along the perimeter of the modular robotic system, wherein penetration of the light curtain suspends operation of one of the robotic arms from the plurality of robotic arms.

### Embodiment 116

The modular robotic system of embodiment 115, wherein penetration of the light curtain suspends operation of the one robotic arm from the plurality of robotic arms without suspending operation of the other robotic arms in the plurality of robotic arms.

### Embodiment 117

The modular robotic system of any one of embodiments 71-116, further comprising a plate input/output module comprising:

a plate identifier configured to identify a plate or a type of plate;

a plate nest, wherein at least one of the robotic arms from the plurality of robotic arms is configured to retrieve a plate from the plate nest or transport a plate to the plate nest; and

an input signaler configured to submit a request to a computer system, which operates a robotic arm selected from the plurality of robotic arms to retrieve the plate from the plate nest.

### Embodiment 118

The modular robotic system of embodiment 117, wherein the plate nest is positioned between a first light curtain and a second light curtain, and the first light curtain is positioned between the plate nest and the selected robotic arm, wherein simultaneous penetration of the first light curtain and the second light curtain suspends operation of the selected robotic arm.

### Embodiment 119

The modular robotic system of embodiment 117 or 118, wherein, in response to the computer system receiving a user request for an identified sample or an identified plate, the selected robotic arm retrieves the identified sample or the identified plate and positions the identified sample or the identified plate within the plate nest of the input/output module.

### Embodiment 120

The modular robotic system of any one of embodiments 71-119, further comprising a plate loading module.

### Embodiment 121

The modular robotic system of embodiment 120, wherein the plate loading module is configured to determine how many plates of a particular plate type are in the plate loading module.

### Embodiment 122

The modular robotic system of embodiment 121, wherein the plate loading module determines how many plates of a particular plate type are in the plate loading module based on the height of a plate stack or a weight of a plate stack.

### Embodiment 123

The modular robotic system of any one of embodiments 71-122, further comprising a barcode applicator.

### Embodiment 124

The modular robotic system of any one of embodiments 71-123, wherein the plate is a sample plate or a consumable plate.

### Embodiment 125

A method of processing a biological sample in a modular robotic system, comprising:

routing a plate to a first node using a first robotic arm;

routing the plate from the first node to a second node, the second node inaccessible by the first robotic arm;

routing the plate from the second node to a sample processing module using a second robotic arm;

routing the plate from the sample processing module to the second node using the second robotic arm; and

routing the plate from the second node to the first node.

### Embodiment 126

A method of processing a biological sample in a modular robotic system, comprising:

routing a plate to a first node using a first robotic arm;

routing the plate from the first node to a second node, the second node being inaccessible by the first robotic arm; and

routing the plate from the second node to a sample processing module using a second robotic arm;

wherein a third robotic arm is disposed between the first robotic arm and the second robotic arm, and the third robotic arm is bypassed when the plate is transported from the first node to the second node.

### Embodiment 127

The method of embodiment 126, further comprising

routing the plate from the sample processing module to the second node using the second robotic arm; and

routing the plate from the second node to the first node.

### Embodiment 128

The method of any one of embodiments 125-127, wherein the plate is a sample plate.

### Embodiment 129

The method of embodiment 128, further comprising processing a sample in the sample plate at the sample processing module.

### Embodiment 130

The method of embodiment 128 or 129 further comprising routing the plate from the first node to a second processing module using the first robotic arm.

### Embodiment 131

The method of embodiment 130, further comprising processing a sample in the sample plate at the second sample processing module.

### Embodiment 132

The method of any one of embodiments 125-131, wherein the plate is a consumable plate.

### Embodiment 133

A method of processing a biological sample in a modular robotic system, comprising:

dynamically routing a sample plate to a selected sample processing module based on stateful data and a defined workflow process, the sample processing module selected from a plurality of sample processing modules based on a real-time load of each of the sample processing modules, wherein a first portion of the plurality of sample processing modules is accessible by a first robotic arm and inaccessible by a second robotic arm, wherein a second portion of the plurality of sample processing modules is accessible by the second robotic arm and inaccessible by the first robotic arm, and wherein the selected sample processing module is in the first portion or the second portion of the plurality of sample processing modules.

### Embodiment 134

The method of embodiment 133, wherein the plurality of sample processing modules are redundant.

### Embodiment 135

The method of embodiment 133 or 134, wherein the second portion of the plurality of sample processing modules comprises the selected sample processing module, and dynamically routing the plate comprises transporting the sample from a first node accessible by the first robotic arm and inaccessible by the second robotic arm to a second node accessible by the second robotic arm and inaccessible by the first robotic arm.

### Embodiment 136

The method of any one of embodiments 133-135, further comprising processing a sample in the sample plate at the selected sample processing module.

### Embodiment 137

The method of any one of embodiments 125-136, comprising receiving a plate input request.

### Embodiment 138

The method of any one of embodiments 125-137, further comprising receiving the plate from an input/output module using the first robotic arm.

### Embodiment 139

The method of any one of embodiments 125-138, comprising receiving a plate output request.

### Embodiment 140

The method of any one of embodiments 125-139, further comprising routing the plate to an input/output module using the first robotic arm.

### Embodiment 141

The method of any one of embodiments 125-140, further comprising:

monitoring a liquid waste volume in a plurality of liquid waste containers; and

disposing of liquid waste contained with the plurality of liquid waste containers according to a liquid waste prioritization schedule.

### Embodiment 142

The method of any one of embodiments 125-141, wherein the plate is routed using a bidirectional plate transportation track.

### Embodiment 143

A non-transitory computer readable storage medium storing instructions, which when executed by one or more processors of a computer system, cause the computer system to perform any one of the methods of embodiments 125-142.

1. A modular robotic system for processing biological samples comprising:
two or more sample processing modules comprising a first sample processing module and a second sample processing module;
a water supply system connected to the two or more sample processing modules, the water supply system comprising a main water supply conduit and one or more water supply manifolds;
a liquid waste disposal system connected to the two or more sample processing modules, the liquid waste disposal system comprising a main liquid waste disposal conduit and one or more liquid waste disposal manifolds connected to at least one sample processing module;
one or more power supply systems connected to a main power supply line and at least one of the two or more sample processing modules;
a bidirectional plate transportation track configured to transport a plate between at least a first node and a second node; and
a plurality of robotic arms comprising a first robotic arm configured to transport the plate between the first node and the first sample processing module, and a second robotic arm configured to transport the plate between the second node and the second sample processing module.

2. The modular robotic system of claim 1, wherein the second sample processing module and the second node are unreachable by the first robotic arm, and the first sample processing module and the first node are unreachable by the second robotic arm.

3. The modular robotic system of claim 1, wherein the plurality of robotic arms further comprises a third robotic arm disposed between the first robotic arm and the second robotic arm, wherein the bidirectional plate transportation track is configured to transport the plate between the first node and the second node without the plate contacting the third robotic arm.

4-7. (canceled)

8. The modular robotic system of claim 1, wherein the water supply system comprises an extendable water supply system terminus.

9-11. (canceled)

12. The modular robotic system of claim 1, wherein the one or more power supply systems are configured to receive power from the main power supply line and supply three-phase alternating current, single-phase alternating current, or direct current to one or more of the two or more sample processing modules.

13-14. (canceled)

15. The modular robotic system of claim 1, further comprising a data network configured to provide communication between the two or more sample processing modules and a computer system.

16. (canceled)

17. The modular robotic system of claim 1, wherein the liquid waste disposal system comprises a valve or regulator disposed between one of the one or more liquid waste disposal manifolds and one of the two or more sample processing modules; and wherein the valve or regulator disposed between the one of the one or more liquid waste disposal manifolds and the one of the two or more sample processing module is operable to selectively open only when flow of liquid waste from any other sample processing module to the liquid waste disposal system is prevented.

18. (canceled)

19. The modular robotic system of claim 17, wherein the valve or regulator is operable to selectively open according to a liquid waste disposal prioritization schedule.

20. The modular robotic system of claim 1, wherein the liquid waste disposal system comprises a pump disposed between one of the one or more liquid waste disposal manifolds and one of the two or more sample processing modules; and wherein the pump disposed between the one of the one or more liquid waste disposal manifolds and the one of the two or more sample processing modules is operable to selectively pump liquid waste into the liquid waste disposal system only when flow of liquid waste from any other sample processing module to the liquid waste disposal system is prevented.

21. (canceled)

22. The modular robotic system of claim 20, wherein the pump is operable to selectively pump liquid waste into the liquid waste disposal system according to a liquid waste prioritization schedule.

23-24. (canceled)

25. The modular robotic system of claim 1, wherein the liquid waste disposal system comprises an extendable liquid waste disposal system terminus.

26-28. (canceled)

29. The modular robotic system of claim 1, further comprising a vacuum system connected to the two or more sample processing modules, the vacuum system comprising a main vacuum conduit and one or more vacuum manifolds.

30. The modular robotic system of claim 29, wherein the vacuum system further comprises a valve disposed between one of the one or more vacuum manifolds and one of the two or more sample processing modules; and wherein the valve disposed between the one of the one or more vacuum manifolds and the one of the two or more sample processing modules is operable to selectively open only when vacuum to any other sample processing module from the vacuum system is prevented.

31. (canceled)

32. The modular robotic system of claim 30, wherein the valve is operable to selectively open according to a vacuum system prioritization schedule.

33. The modular robotic system of claim 29, wherein the vacuum system comprises an extendable vacuum system terminus.

34-36. (canceled)

37. The modular robotic system of claim 1, further comprising a compressed gas system connected to the two or more sample processing modules, the compressed gas system comprising a main compressed gas supply conduit and one or more compressed gas manifolds.

38. The modular robotic system of claim 37, wherein the compressed gas system further comprises a valve disposed between one of the one or more compressed gas manifolds and one of the two or more sample processing modules; and wherein the valve disposed between the one of the one or more compressed gas manifolds and the one of the two or more sample processing modules is operable to selectively open only when compressed gas to any other sample processing module from the compressed gas system is prevented.

39. (canceled)

40. The modular robotic system of claim 38, wherein the valve is operable to selectively open according to a compressed gas system prioritization schedule.

41. The modular robotic system of claim 37, wherein the compressed gas system comprises an extendable compressed gas system terminus.

42-44. (canceled)

45. The modular robotic system of claim 1, further comprising a light curtain disposed along the perimeter of the modular robotic system, wherein penetration of the light curtain suspends operation of one of the robotic arms from the plurality of robotic arms.

46. The modular robotic system of claim 45, wherein penetration of the light curtain suspends operation of the one robotic arm from the plurality of robotic arms without suspending operation of the other robotic arms in the plurality of robotic arms.

47. The modular robotic system of claim 1, further comprising a plate input/output module comprising:
a plate identifier configured to identify a plate or a type of plate;
a plate nest, wherein at least one of the robotic arms from the plurality of robotic arms is configured to retrieve a plate from the plate nest or transport a plate to the plate nest; and
an input signaler configured to submit a request to a computer system, which operates a robotic arm selected from the plurality of robotic arms to retrieve the plate from the plate nest.

48. The modular robotic system of claim 47, wherein the plate nest is positioned between a first light curtain and a second light curtain, and the first light curtain is positioned between the plate nest and the selected robotic arm, wherein simultaneous penetration of the first light curtain and the second light curtain suspends operation of the selected robotic arm.

49. The modular robotic system of claim 47, wherein, in response to the computer system receiving a user request for an identified sample or an identified plate, the selected robotic arm retrieves the identified sample or the identified plate and positions the identified sample or the identified plate within the plate nest of the input/output module.

50. The modular robotic system of claim 1, further comprising a plate loading module.

51. The modular robotic system of claim 50, wherein the plate loading module is configured to determine how many plates of a particular plate type are in the plate loading module.

52. (canceled)

53. The modular robotic system of claim 1, further comprising a barcode applicator.

54. (canceled)

55. A method of processing a biological sample in a modular robotic system, comprising:
routing a plate to a first node using a first robotic arm;
routing the plate from the first node to a second node, the second node inaccessible by the first robotic arm;
routing the plate from the second node to a sample processing module using a second robotic arm;
routing the plate from the sample processing module to the second node using the second robotic arm; and
routing the plate from the second node to the first node.

56. A method of processing a biological sample in a modular robotic system, comprising:
routing a plate to a first node using a first robotic arm;
routing the plate from the first node to a second node, the second node being inaccessible by the first robotic arm; and
routing the plate from the second node to a sample processing module using a second robotic arm;
wherein a third robotic arm is disposed between the first robotic arm and the second robotic arm, and the third robotic arm is bypassed when the plate is transported from the first node to the second node.

57-62. (canceled)

63. A method of processing a biological sample in a modular robotic system, comprising:
dynamically routing a sample plate to a selected sample processing module based on stateful data and a defined workflow process, the sample processing module selected from a plurality of sample processing modules based on a real-time load of each of the sample processing modules, wherein a first portion of the plurality of sample processing modules is accessible by a first robotic arm and inaccessible by a second robotic arm, wherein a second portion of the plurality of sample processing modules is accessible by the second robotic arm and inaccessible by the first robotic arm, and wherein the selected sample processing module is in the first portion or the second portion of the plurality of sample processing modules.

64-73. (canceled)
